(19) United States
(12) Patent Application Publication
(10) Pub. No.: US 2026/0129247 A1
(43) Pub. Date: May 7, 2026

(54) METHOD, APPARATUS, AND MEDIUM FOR VIDEO PROCESSING

(71) Applicant: Bytedance Inc., Los Angeles, CA (US)

(72) Inventors: Jizheng XU, Los Angeles, CA (US); Ye-Kui WANG, Los Angeles, CA (US)

(21) Appl. No.: 19/438,405

(22) Filed: Dec. 31, 2025

Related U.S. Application Data
(63) Continuation of application No. PCT/US2024/036589, filed on Jul. 2, 2024.
(60) Provisional application No. 63/511,818, filed on Jul. 3, 2023.
(60) Provisional application No. 63/513,456, filed on Jul. 13, 2023.

(51) Int. Cl. H04N 19/86; H04N 19/30; H04N 19/88

(52) U.S. Cl. CPC H04N 19/86; H04N 19/30; H04N 19/88

(57) ABSTRACT

Embodiments of the present disclosure provide a solution for video processing. A method for video processing is proposed. The method comprises: performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

### CROSS REFERENCE

This application is a continuation of International Application No. PCT/US2024/036589, filed on Jul. 2, 2024, which claims the benefit of U.S. Provisional Application No. 63/511,818, filed on Jul. 3, 2023, and U.S. Provisional Application No. 63/513,456, filed on Jul. 13, 2023. The entire contents of these applications are hereby incorporated by reference in their entireties.

### FIELDS

Embodiments of the present disclosure relates generally to video processing techniques, and more particularly, to a neural-network post-processing filter (NNPF).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, the functionality of video coding techniques is generally expected to be further improved.

### SUMMARY

Embodiments of the present disclosure providc a solution for video processing.

In a first aspect, a method for video processing is proposed. The method comprises: performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

Based on the method in accordance with the first aspect of the present disclosure, it is specified that a generation of at least one NNPF output picture is performed no more than once between any particular pair of consecutive input pictures. Compared with the conventional solution lacking such a constraint, the proposed method can advantageously avoid multiple output pictures in one NNPF inference instance. Thereby, a proper functionality of NNPF can be ensured.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

In a fifth aspect, a method for storing a bitstream of a video is proposed. The method comprises: generating the bitstream from the video; and storing the bitstream in a non-transitory computer-readable recording medium, wherein a neural-network post-processing filter (NNPF) is applied on a current picture associated with the video based on at least one input picture for the NNPF, and a generation of at least one NNPF output picture is performed no more than once between any particular pair of consecutive input pictures.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of luma data channels;

FIG. 5 illustrates a flowchart of a method for video processing in accordance with embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

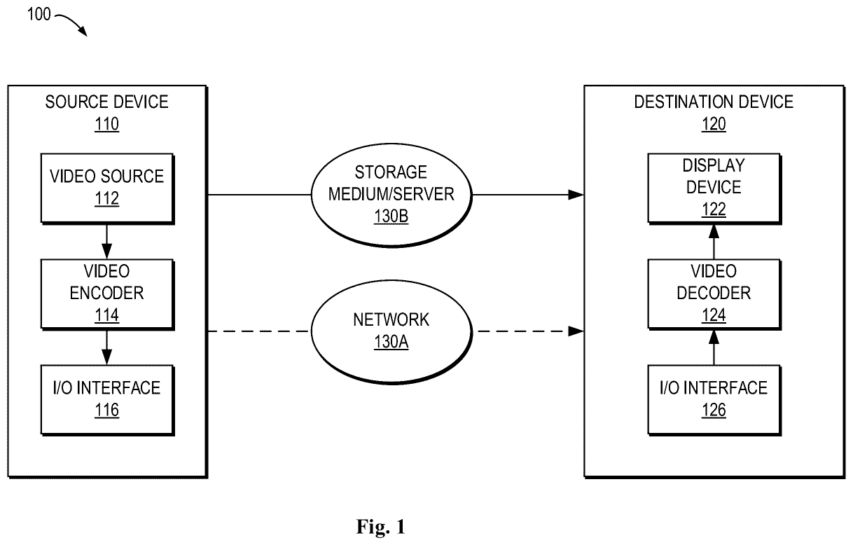

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

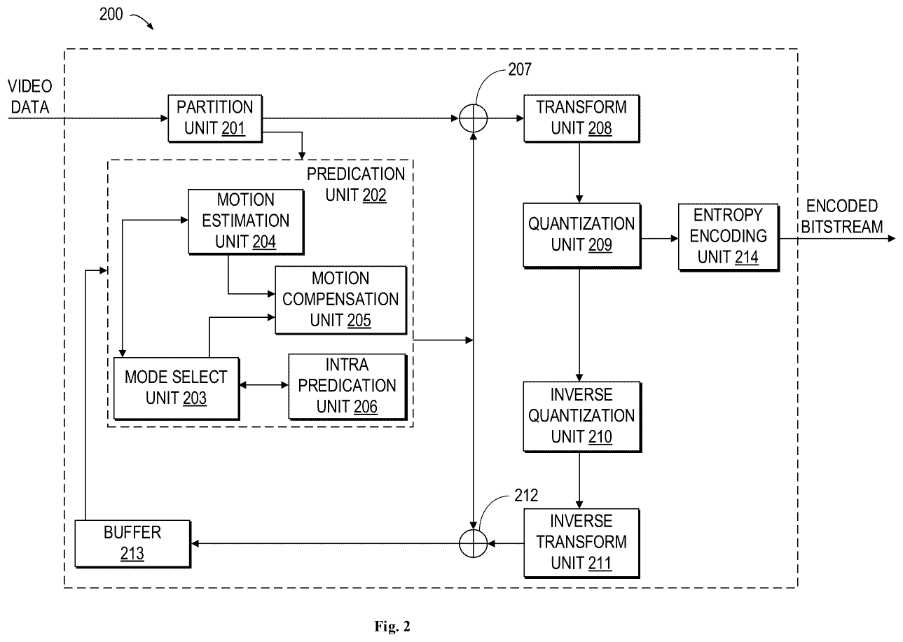

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components.

The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and providc the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block.

The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

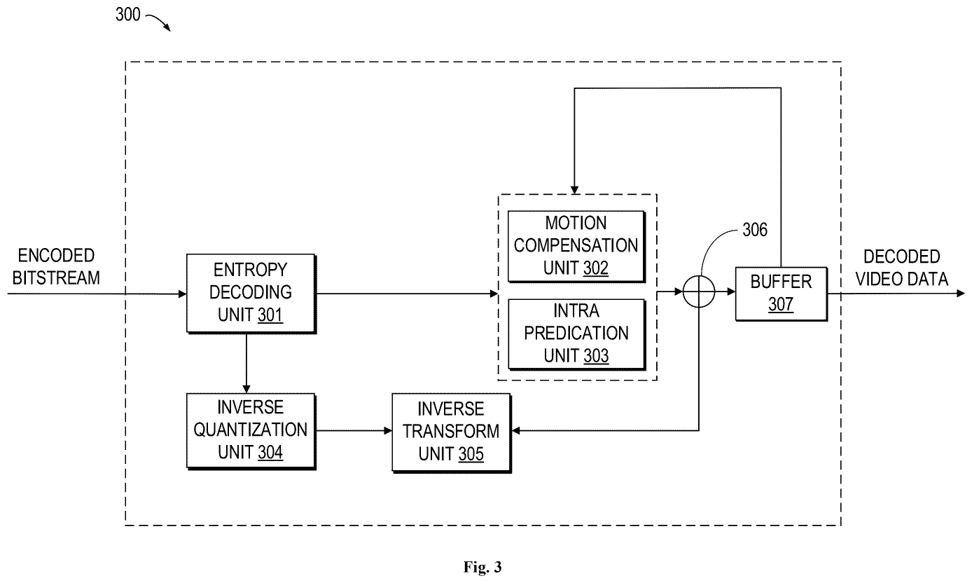

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure.

In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter.

It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Initial Discussion

This document is related to image/video coding technologies. Specifically, this disclosure is related to the value ranges and coding methods of indicator syntax elements in neural-network post-filter (NNPF) SEI messages. The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. Abbreviations

adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC).

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM). The JVET was later renamed to be the Joint Video Experts Team (JVET) when the Versatile Video Coding (VVC) project officially started. VVC is a coding standard targeting at 50% bitrate reduction as compared to HEVC.

The Versatile Video Coding (VVC) standard (ITU-T H.266 I ISO/IEC 23090-3) and the associated Versatile Supplemental Enhancement Information for coded video bitstreams (VSEI) standard (ITU-T H.274 ISO/IEC 23002-7) are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3 Signalling of Neural-Network Post Filters

JVET-AD2006 includes the specification of two SEI messages for signalling of neural-network post-filters, namely the neural-network post-filter characteristics (NNPFC) SEI message and the neural-network post-filter activation (NNPFA) SEI. JVET-AD2005 includes the specification of the use of the NNPFC SEI message in VVC bitstreams.

An excerpt from the specification of NNPFC and NNPFA SEI messages in JVET-AD2006 and the specification of the use of the NNPFC SEI message in VVC bitstreams are as follows.

### 8.28 Neural-Network Post-Filter SEI Messages

### 8.28.1 General Post-Processing Filtering Process Using NNPFs

### 8.28.1.1 General

Input to this process is a bitstream BitstreamToFilter. Output of this process is a list of NNPF output pictures ListNnpfOutputPics.

First, BitstreamToFilter is decoded, and the list CroppedDecodedPictures is set to be the list of the cropped decoded pictures in output order resulted from decoding BitstreamToFilter.

Second, the filtering process for one picture, as specified in subclause 8.28.1.2, is repeatedly invoked, in output order, for each cropped decoded picture that is in CroppedDecodedPictures and for which one or more NNPFs are activated.

The order of the pictures in ListNnpfOutputPics is in output order.

Within ListNnpfOutputPics there shall be no more than one picture pertaining to any particular output time instance. When for any particular picture in CroppedDecodedPictures there are multiple NNPFs activated and only one the NNPFs is allowed to be chosen to be applied although any of the NNPFs may be chosen, the above constraint shall apply regardless of which NNPF is chosen to be applied to the particular picture.

### 8.28.1.2 Filtering Process for One Picture Using an NNPF

The filtering process specified in this subclause applies to each cropped decoded picture, referred to as the current picture, that is in CroppedDecodedPictures and for which one or more NNPFs are activated.

When applying an NNPF to the current picture, the filtered and/or interpolated pictures are generated by the NNPF by applying the NNPF process specified in the semantics of the NNPFC SEI message, in a patch-wise manner, to the current picture.

When applying an NNPF to the current picture, the order of the pictures generated by the NNPF by applying the NNPF process being stored into the output tensor of the NNPF is in output order.

When the applied NNPF is the last NNPF that is applied to the current picture, the pictures generated by the NNPF and output by the NNPF process are included into ListNnpfOutputPics, in the same order as when the pictures are stored into the output tensor of the NNPF.

### 8.28.2 Neural-Network Post-Filter Characteristics SEI Message

### 8.28.2.1 Neural-Network Post-Filter Characteristics SEI Message Syntax

| | Descriptor |
|---|---|
| nn_post_filter_characteristics( payloadSize ) { | |
| nnpfc_purpose | u(16) |
| nnpfc_id | ue(v) |
| nnpfc_base_flag | u(1) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_property_present_flag | u(1) |
| if( nnpfc_property present_flag ) { | |
| /* input and output formatting */ | |
| nnpfc_num_input_pics_minus1 | ue(v) |
| if( nnpfc_num_input_pics_minus1 > 0 ) { | |
| for( i = 0; i <= nnpfc_num_input_pics_minus1; | |
| i++ ) | |
| nnpfc_input_pic_output_flag[ i ] | u(1) |
| nnpfc_absent_input_pic_zero_flag | u(1) |
| } | |
| if( chromaUpsamplingFlag ) | |
| nnpfc_out_sub_c_flag | u(1) |
| if( colourizationFlag ) | |
| nnpfc_out_colour_format_idc | u(2) |
| if( resolutionResamplingFlag ) { | |
| nnpfc_pic_width_num_minus1 | ue(v) |
| nnpfc_pic_width_denom_minus1 | ue(v) |
| nnpfc_pic_height_num_minus1 | ue(v) |
| nnpfc_pic_height_denom_minus1 | ue(v) |
| } | |
| if( pictureRateUpsamplingFlag ) | |
| for( i = 0; i < nnpfc_num_input_pics_minus1; i++ ) | |
| nnpfc_interpolated_pics[ i ] | ue(v) |
| nnpfc_component_last_flag | u(1) |
| nnpfc_inp_format_idc | ue(v) |
| nnpfc_auxiliary_inp_idc | ue(v) |
| nnpfc_inp_order_idc | ue(v) |
| if( nnpfc_inp_format_idc = = 1 ) { | |
| if( nnpfc_inp_order_idc != 1 ) | |
| nnpfc_inp_tensor_luma_bitdepth_minus8 | ue(v) |
| if( nnpfc_inp_order_idc != 0 ) | |
| nnpfc_inp_tensor_chroma_bitdepth_minus8 | ue(v) |
| } | |
| nnpfc_out_format_idc | ue(v) |
| nnpfc_out_order_idc | ue(v) |
| if( nnpfc_out_format_idc = = 1 ) { | |
| if( nnpfc_out_order_idc != 1 ) | |
| nnpfc_out_tensor_luma_bitdepth_minus8 | ue(v) |
| if( nnpfc_out_order_idc != 0 ) | |
| nnpfc_out_tensor_chroma_bitdepth_minus8 | ue(v) |
| } | |
| nnpfc_separate_colour_description_present_flag | u(1) |
| if( nnpfc_separate_colour_description_present_flag ) | |
| { | |
| nnpfc_colour_primaries | u(8) |
| nnpfc_transfer_characteristics | u(8) |
| if( nnpfc_out_format_idc = = 1 ) { | |
| nnpfc_matrix_coeffs | u(8) |
| nnpfc_full_range_flag | u(1) |
| } | |
| } | |
| nnpfc_chroma_loc_info_present_flag | u(1) |
| if( nnpfc_chroma_loc_info_present_flag ) | |
| nnpfc_chroma_sample_loc_type_frame | ue(v) |
| nnpfc_overlap | ue(v) |
| nnpfc_constant_patch_size_flag | u(1) |
| if( nnpfc_constant_patch_size_flag ) { | |
| nnpfc_patch_width_minus1 | ue(v) |
| nnpfc_patch_height_minus1 | ue(v) |
| } else { | |
| nnpfc_extended_patch_width_cd_delta_minus1 | ue(v) |
| nnpfc_extended_patch_height_cd_delta_minus1 | ue(v) |
| } | |
| nnpfc_padding_type | ue(v) |
| if( nnpfc_padding_type = = 4 ) { | |
| if( nnpfc_inp_order_idc != 1 ) | |
| nnpfc_luma_padding_val | ue(v) |
| if( nnpfc_inp_order_idc != 0 ) { | |
| nnpfc_cb_padding_val | ue(v) |
| nnpfc_cr_padding_val | ue(v) |
| } | |
| } | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| nnpfc_metadata_extension_num_bits | ue(v) |
| if( nnpfc_metadata_extension_num_bits > 0 ) | |
| nnpfc_reserved_metadata_extension | u(v) |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

### 8.28.2.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
Input picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepth_{Y} for the luma sample array of the input pictures.
Bit depth BitDepth_{C} for the chroma sample arrays, if any, of the input pictures.
A chroma format indicator, denoted herein by ChromaFormatIdc, as described in subclause 7.3.
When nnpfc_auxiliary_inp_idc is equal to 1, a filtering strength control value array StrengthControlVal[idx] that shall contain real numbers in the range of 0 to 1, inclusive, of the input pictures with index idx in the range of 0 to numInputPics−1, inclusive.

Input picture with index 0 corresponds to the picture for which the NNPF defined by this NNPFC SEI message is activated by an NNPFA SEI message. Input picture with index i in the range of 1 to numInputPics−1, inclusive, precedes the input picture with index i−1 in output order.

The variables SubWidthC and SubHeightC are derived from ChromaFormatIdc as specified by Table 2.

NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_purpose indicates the purpose of the NNPF as specified in Table 1, where (nnpfc_purpose & bitMask) not equal to 0 indicates that the NNPF has the purpose associated with the bitMask value in Table 1. When nnpfc_purpose is greater than 0 and (nnpfc_purpose & bitMask) is equal to 0, the purpose associated with the bitMask value is not applicable to the NNPF. When nnpfc_pupose is equal to 0, the NNPF may be used as determined by the application.

The value of nnpfc_purpose shall be in the range of 0 to 63, inclusive, in bitstreams conforming to this edition of this document. Values of 64 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 to 65 535, inclusive.

TABLE 1
Definition of nnpfc_purpose

| bitMask | Interpretation |
|---|---|
| 0x01 | General visual quality improvement |
| 0x02 | Chroma upsampling (from the 4:2:0 chroma format to the |
| | 4:2:2 or 4:4:4 chroma format, or from the 4:2:2 chroma |
| | format to the 4:4:4 chroma format) |
| 0x04 | Resolution resampling (increasing or decreasing the |
| | width or height) |
| 0x08 | Picture rate upsampling |
| 0x10 | Bit depth upsampling (increasing the luma bit depth or |
| | the chroma bit depth) |
| 0x20 | Colourization |

The variables chromaUpsamplingFlag, resolutionResamplingFlag, pictureRateUpsamplingFlag, bitDepthUpsamplingFlag, and colourizationFlag, specifying whether nnpfc_purpose indicates the purpose of the NNPF to include chroma upsampling, resolution resampling, picture rate upsampling, bit depth upsampling, and colourization, respectively, are derived as follows:

chromaUpsamplingFlag = ( ( nnpfc_purpose & 0x02 ) > 0 ) ? 1 : 0
resolutionResamplingFlag = ( ( nnpfc_purpose & 0x04 ) > 0 ) ? 1 : 0

| | |
|---|---|
| pictureRateUpsamplingFlag = ( ( nnpfc_purpose & 0x08 ) > 0 ) ? 1 : 0 | (76) |

bitDepthUpsamplingFlag = ( ( nnpfc_purpose & 0x10 ) > 0 ) ? 1 : 0
colourizationFlag = ( ( nnpfc_purpose & 0x20 ) > 0 ) ? 1 : 0

NOTE 2—When a reserved value of nnpfc_purpose is taken into use in the future by ITU-T ISO/IEC, the syntax of this SEI message could be extended with syntax elements whose presence is conditioned by nnpfc_purpose being equal to that value.

When ChromaFormatIdc is equal to 3, chromaUpsamplingFlag shall be equal to 0.

When ChromaFormatIdc or chromaUpsamplingFlag is not equal to 0, colourizationFlag shall be equal to 0.

When pictureRateUpsamplingFlag is equal to 1 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

nnpfc_id contains an identifying number that may be used to identify an NNPF. The value of nnpfc_id shall be in the range of 0 to 2³²−2, inclusive. Values of nnpfc_id from 256 to 511, inclusive, and from 2³¹ to 2³²−2, inclusive, are reserved for future use by ITU-T|ISO/IEC. Decoders conforming to this edition of this document encountering an NNPFC SEI message with nnpfc_id in the range of 256 to 511, inclusive, or in the range of 2³¹ to 2³²−2, inclusive, shall ignore the SEI message.

When an NNPFC SEI message is the first NNPFC SEI message, in decoding order, that has a particular nnpfc_id value within the current CLVS, the following applies:
This SEI message specifies a base NNPF.
This SEI message pertains to the current decoded picture and all subsequent decoded pictures of the current layer, in output order, until the end of the current CLVS.

nnpfc_base_flag equal to 1 specifies that the SEI message specifies the base NNPF. nnpf_base_flag equal to 0 specifies that the SEI message specifies an update relative to the base NNPF.

The following constraints apply to the value of nnpfc_base_flag:
When an NNPFC SEI message is the first NNPFC SEI message, in decoding order, that has a particular nnpfc_id value within the current CLVS, the value of nnpfc_base_flag shall be equal to 1.
When an NNPFC SEI message nnpfcB is not the first NNPFC SEI message, in decoding order, that has a particular nnpfc_id value within the current CLVS and the value of nnpfc_base_flag is equal to 1, the NNPFC SEI message shall be a repetition of the first NNPFC SEI message nnpfcA with the same nnpfc_id value, in decoding order, i.e., the payload content of nnpfcB shall be the same as that of nnpfcA.

When nnpfc_base_flag is equal to 0, the following applies:
This SEI message defines an update relative to the preceding base NNPF in decoding order with the same nnpfc_id value. Updates are not cumulative but rather each update is applied on the base NNPF, which is the NNPF specified by the first NNPFC SEI message, in decoding order, that has a particular nnpfc_id value within the current CLVS. The NNPF defined by this SEI message is obtained by applying the update defined by this SEI message relative to the base NNPF with the same nnpfc_id value.
This SEI message pertains to the current decoded picture and all subsequent decoded pictures of the current layer, in output order, until the end of the current CLVS or up to but excluding the decoded picture that follows the current decoded picture in output order within the current CLVS and is associated with a subsequent NNPFC SEI message, in decoding order, having nnpfc_base_flag equal to 0 and that particular nnpfc_id value within the current CLVS, whichever is earlier.

nnpfc_mode_idc equal to 0 indicates that this SEI message contains an ISO/IEC 15938-17 bitstream that specifies a base NNPF (when nnpfc_base_flag is equal to 1) or is an update relative to the base NNPF with the same nnpfc_id value (when nnpfc_base_flag is equal to 0).

When nnpfc_base_flag is equal to 1, nnpfc_mode_idc equal to 1 specifies that the base NNPF associated with the nnpfc_id value is a neural network identified by the URI indicated by nnpfc_uri with the format identified by the tag URI nnpfc_tag_uri.

When nnpfc_base_flag is equal to 0, nnpfc_mode_idc equal to 1 specifies that an update relative to the base NNPF with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T|ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base NNPF or an update relative to the base NNPF with the same nnpfc_id value specified by nnpfc_uri.

NOTE 3—nnpfc_tag_uri enables uniquely identifying the format of neural network data specified by nnrpf_uri without needing a central registration authority.

nnpfc_tag_uri equal to “tag:iso.org,2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base NNPF or an update relative to the base NNPF with the same nnpfc_id value.

nnpfc_property_present_flag equal to 1 specifies that syntax elements related to the filter purpose, input formatting, output formatting, and complexity are present. nnpfc_property_present_flag equal to 0 specifies that no syntax elements related to the filter purpose, input formatting, output formatting, and complexity are present.

When nnpfc_base_flag is equal to 1, nnpfc_property_present_flag shall be equal to 1.

When nnpfc_property_present_flag is equal to 0, the values of all syntax elements that may be present only when nnpfc_property_present_flag is equal to 1 are inferred to be equal to their corresponding syntax elements, respectively, in the NNPFC SEI message that contains the base NNPF for which this SEI message provides an update.

When an NNPFC SEI message nnpfcCurr is not the first NNPFC SEI message, in decoding order, that has a particular nnpfc_id value within the current CLVS, is not a repetition of the first NNPFC SEI message with that particular nnpfc_id (i.e., the value of nnpfc_base_flag is equal to 0), and the value of nnpfc_property_present_flag is equal to 1, the following constraints apply:
The value of nnpfc_purpose in the NNPFC SEI message shall be the same as the value of nnpfc_purpose in the first NNPFC SEI message, in decoding order, that has that particular nnpfc_id value within the current CLVS.
The values of syntax elements following nnpfc_property_present_flag and preceding nnpfc_complexity_info_present_flag, in decoding order, in the NNPFC SEI message shall be the same as the values of corresponding syntax elements in the first NNPFC SEI message, in decoding order, that has that particular nnpfc_id value within the current CLVS.
Either nnpfc_complexity_info_present_flag shall be equal to 0 or both nnpfc_complexity_info_present_flag shall be equal to 1 in the first NNPFC SEI message, in decoding order, that has that particular nnpfc_id value within the current CLVS (denoted as nnpfcBase below) and all the following apply:
   nnpfc_parameter_type_idc in nnpfcCurr shall be equal to nnpfc_parameter_type_idc in nnpfcBase.
   nnpfc_log 2_parameter_bit_length_minus3 in nnpfcCurr, when present, shall be less than or equal to nnpfc_log 2_parameter_bit_length_minus3 in nnpfcBase.
   If nnpfc_num_parameters_idc in nnpfcBase is equal to 0, nnpfc_num_parameters_idc in nnpfcCurr shall be equal to 0.
   Otherwise (nnpfc_num_parameters_idc in nnpfcBase is greater than 0), nnpfc_num_parameters_idc in nnpfcCurr shall be greater than 0 and less than or equal to nnpfc_num_parameters_idc in nnpfcBase.
   If nnpfc_num_kmac_operations_idc in nnpfcBase is equal to 0, nnpfc_num_kmac_operations_idc in nnpfcCurr shall be equal to 0.
   Otherwise (nnpfc_num_kmac_operations_idc in nnpfcBase is greater than 0), nnpfc_num_kmac_operations_idc in nnpfcCurr shall be greater than 0 and less than or equal to nnpfc_num_kmac_operations_idc in nnpfcBase.
If nnpfc_total_kilobyte_size in nnpfcBase is equal to 0, nnpfc_total_kilobyte_size in nnpfcCurr shall be equal to 0.
Otherwise (nnpfc_total_kilobyte_size in nnpfcBase is greater than 0), nnpfc_total_kilobyte_size in nnpfcCurr shall be greater than 0 and less than or equal to nnpfc_total_kilobyte_size in nnpfcBase.

nnpfc_num_input_pics_minus1 plus 1 specifies the number of pictures used as input for the NNPF. The value of nnpfc_num_input_pics_minus1 shall be in the range of 0 to 63, inclusive. When pictureRateUpsamplingFlag is equal to 1, the value of nnpfc_num_input_pics_minus1 shall be greater than 0.

The variable numInputPics, specifying the number of pictures used as input for the NNPF, is derived as follows:

$$numInputPics = nnpfc\_num \_input \_pics \_minus 1 + 1 \qquad ( 77 )$$

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture. When nnpfc_num_input_pics_minus1 is equal to 0, nnpfc_input_pic_output_flag[0] is inferred to be equal to 1. When pictureRateUpsamplingFlag is equal to 0 and nnpfc_num_input_pics_minus1 is greater than 0, nnpfc_input_pic_output_flag[i] shall be equal to 1 for at least one value of i in the range of 0 to nnpfc_num_input_pics_minus1, inclusive.

nnpfc_absent_input_pic_zero_flag equal to 1 indicates that the NNPF expects an input picture that is not present in the bitstream to be represented by sample arrays with sample values equal to 0. nnpfc_absent_input_pic_zero_flag equal to 0 indicates that the NNPF expects an input picture that is not present in the bitstream to be represented by the closest input picture in output order within the bitstream.

nnpfc_out_sub_c_flag specifies the values of the variables outSubWidthC and outSubHeightC when chromaUpsamplingFlag is equal to 1. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When ChromaFormatIdc is equal to 2 and nnpfc_out_sub_c_flag is present, the value of nnpfc_out_sub_c_flag shall be equal to 1.

nnpfc_out_colour_format_idc, when colourizationFlag is equal to 1, specifies the colour format of the NNPF output and consequently the values of the variables outSubWidthC and outSubHeightC. nnpfc_out_colour_format_idc equal to 1 specifies that the colour format of the NNPF output is the 4:2:0 format and outSubWidthC and outSubHeightC are both equal to 2. nnpfc_out_colour_format_idc equal to 2 specifies that the colour format of the NNPF output is the 4:2:2 format and outSubWidthC is equal to 2 and outSubHeightC is equal to 1. nnpfc_out_colour_format_idc equal to 3 specifies that the colour format of the NNPF output is the 4:4:4 format and outSubWidthC and outSubHeightC are both equal to 1. The value of nnpfc_out_colour_format_idc shall not be equal to 0.

When chromaUpsamplingFlag and colourizationFlag are both equal to 0, outSubWidthC and outSubHeightC are inferred to be equal to SubWidthC and SubHeightC, respectively.

nnpfc_pic_width_num_minus1 plus 1 and nnpfc_pic_width_denom_minus1 plus 1 specify the numerator and denominator, respectively, for the resampling ratio of the NNPF output picture width relative to CroppedWidth. The value of (nnpfc_pic_width_num_minus1+1)÷(nnpfc_pic_width_denom_minus1+1) shall be in the range of 1÷16 to 16, inclusive. When nnpfc_pic_width_num_minus1 and nnpfc_pic_width_denom_minus1 are not present, the values of nnpfc_pic_width_num_minus1 and nnpfc_pic_width_denom_minus1 are both inferred to be equal to 0.

The variable nnpfcOutputPicWidth, representing the width of the luma sample arrays of the picture(s) resulting from applying the NNPF identified by nnpfc_id to the input picture(s), is derived as follows:

nnpfcOutputPicWidth = Ceil( CroppedWidth *(78)
( nnpfc_pic_width_num_minus1 + 1 ) ÷ ( nnpfc_pic_width_denom_minus1 + 1 ) )

It is a requirement of bitstream conformance that the value of nnpfcOutputPicWidth % outSubWidthC shall be equal to 0.

nnpfc_pic_height_num_minus1 plus 1 and nnpfc_pic_height_denom_minus1 plus 1 specify the numerator and denominator, respectively, for the resampling ratio of the NNPF output picture height relative to CroppedHeight. The value of (nnpfc_pic_height_num_minus1+1)÷(nnpfc_pic_height_denom_minus1+1) shall be in the range of 1÷16 to 16, inclusive. When nnpfc_pic_height_num_minus1 and nnpfc_pic_height_denom_minus1 are not present, the values of nnpfc_pic_height_num_minus1 and nnpfc_pic_height_denom_minus1 are both inferred to be equal to 0.

The variable nnpfcOutputPicHeight, representing the height of the luma sample arrays of the picture(s) resulting from applying the NNPF identified by nnpfc_id to the input picture(s), is derived as follows:

nnpfcOutputPicHeight = Ceil( CroppedHeight *(79)
( nnpfc_pic_height_num_minus1 + 1 ) ÷ ( nnpfc_pic_height_denom_minus1 + 1 ) )

It is a requirement of bitstream conformance that the value of nnpfcOutputPicHeight % outSubHeightC shall be equal to 0.

When nnpfc_pic_width_num_minus1, nnpfc_pic_width_denom_minus1, nnpfc_pic_height_num_minus1, and nnpfc_pic_height_denom_minus1 are present, at least one the following shall be true:
The value of nnpfcOutputPicWidth is not equal to CroppedWidth.
The value of nnpfcOutputPicHeight is not equal to CroppedHeight.

nnpfc_interpolated_pics[i] specifies the number of interpolated pictures generated by the NNPF between the i-th and the (i+1)-th picture used as input for the NNPF. The value of nnpfc_interpolated_pics[i] shall be in the range of 0 to 63, inclusive. The value of nnpfc_interpolated_pics[i] shall be greater than 0 for at least one value of i in the range of 0 to nnpfc_num_input_pics_minus1−1, inclusive.

The variables NumInpPicsInOutputTensor, specifying the number of pictures that have a corresponding input picture and are present in the output tensor of the NNPF, InpIdx[idx] specifying the input picture index of the idx-th picture that is present in the output tensor of the NNPF and has a corresponding input picture, and numOutputPics, specifying the total number of pictures present in the output tensor of the NNPF, are derived as follows:

| for( i = 0, numOutputPics = 0; i < numInputPics; i++ ) | |
|---|---|
| if( nnpfc_input_pic_output_flag[ i ] ) { | |
| InpIdx[ numOutputPics ] = i | |
| numOutputPics++ | |
| } | (80) |

NumInpPicsInOutputTensor = numOutputPics
if( pictureRateUpsamplingFlag )
for( i = 0; i <= numInputPics − 2; i++ )
numOutputPics += nnpfc_interpolated_pics[ i ]

nnpfc_component_last_flag equal to 1 indicates that the last dimension in the input tensor inputTensor to the NNPF and the output tensor outputTensor resulting from the NNPF is used for a current channel. nnpfc_component_last_flag equal to 0 indicates that the third dimension in the input tensor inputTensor to the NNPF and the output tensor outputTensor resulting from the NNPF is used for a current channel.

NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.

NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the input picture to an input value to the NNPF. When nnpfc_inp_format_idc is equal to 0, the input values to the NNPF are real numbers and the functions InpY( ) and InpC( ) are specified as follows:

| InpY( x ) = x ÷ ( ( 1 << BitDepth_{Y} ) − 1 ) (81) | |
|---|---|
| InpC( x )= x ÷ ( ( 1 << BitDepth_{C} ) − 1 ) | (82) |

When nnpfc_inp_format_idc is equal to 1, the input values to the NNPF are unsigned integer numbers and the functions InpY( ) and InpC( ) are specified as follows:

shiftY = BitDepth_{Y} − inpTensorBitDepth_{Y}
if( inpTensorBitDepth_{Y} >= BitDepth_{Y})

| | |
|---|---|
| InpY( x ) = x << ( inpTensorBitDepth_{Y} − BitDepth_{Y} ) | (83) |

else
InpY( x ) = Clip3(0, ( 1 << inpTensorBitDepth_{Y} ) − 1, ( x + ( 1 << ( shiftY − 1 ) ) ) >> shiftY )
shiftC = BitDepth_{C} − inpTensorBitDepth_{C}
if( inpTensorBitDepth_{C} >= BitDepth_{C} )

| | |
|---|---|
| InpC( x ) = x << ( inpTensorBitDepth_{C} − BitDepth_{C} ) | (84) |

else
InpC( x ) = Clip3(0, ( 1 << inpTensorBitDepth_{C} ) − 1, ( x + ( 1 << ( shiftC − 1 ) ) ) >> shiftC )

The variable inpTensorBitDepthY is derived from the syntax element nnpfc_inp_tensor_luma_bitdepth_minus8 as specified below. The variable inpTensorBitDepthC is derived from the syntax element nnpfc_inp_tensor_chroma_bitdepth_minus8 as specified below.

Values of nnpfc_inp_format_idc greater than 1 are reserved for future specification by ITU-T ISO/IEC and shall not be present in bitstreams conforming to this edition of this document. Decoders conforming to this edition of this document shall ignore NNPFC SEI messages that contain reserved values of nnpfc_inp_format_idc.

nnpfc_auxiliary_inp_idc greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 85.

The value of nnpfc_auxiliary_inp_idc shall be in the range of 0 to 1, inclusive, in bitstreams conforming to this edition of this document. Values of 2 to 255, inclusive, for nnpfc_auxiliary_inp_idc are reserved for future use by ITU-T|ISO/IEC and shall not be present in bitstreams conforming to this edition of this document. Decoders conforming to this edition of this document shall ignore NNPFC SEI messages with nnpfc_auxiliary_inp_idc in the range of 2 to 255, inclusive. Values of nnpfc_auxiliary_inp_idc greater than 255 shall not be present in bitstreams conforming to this edition of this document and are not reserved for future use.

nnpfc_inp_order_idc indicates the method of ordering the sample arrays of an input picture to form an input tensor to the NNPF.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

When ChromaFormatIdc is equal to 0, nnpfc_inp_order_idc shall be equal to 0.

When chromaUpsamplingFlag is equal to 1, nnpfc_inp_order_idc shall not be equal to 0.

Table 2 contains an informative description of nnpfc_inp_order_idc values.

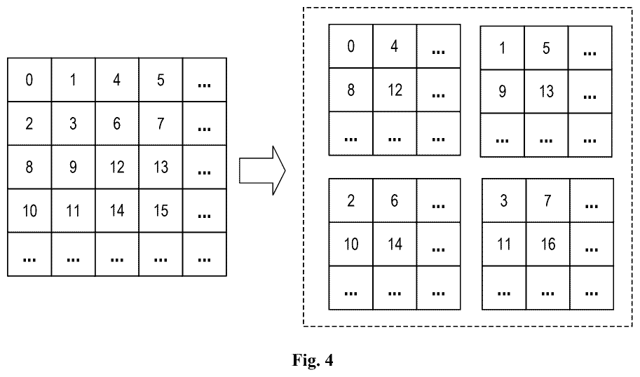

TABLE 2
Description of nnpfc_inp_order_idc values

| nnpfc_inp_{—} | |
|---|---|
| order_idc | Description |
| 0 | If nnpfc_auxiliary_inp_idc is equal to 0, one luma matrix is present in the input tensor |
| | for each input picture, and the number of channels is 1. Otherwise, when |
| | nnpfc_auxiliary_inp_idc is equal to 1, one luma matrix and one auxiliary input matrix are |
| | present, and the number of channels is 2. |
| 1 | If nnpfc_auxiliary_inp_idc is equal to 0, two chroma matrices are present in the input |
| | tensor, and the number of channels is 2. Otherwise, when nnpfc_auxiliary_inp_idc is |
| | equal to 1, two chroma matrices and one auxiliary input matrix are present, and the |
| | number of channels is 3. |
| 2 | If nnpfc_auxiliary_inp_idc is equal to 0, one luma and two chroma matrices are present |
| | in the input tensor, and the number of channels is 3. Otherwise, when |
| | nnpfc_auxiliary_inp_idc is equal to 1, one luma matrix, two chroma matrices and one |
| | auxiliary input matrix are present, and the number of channels is 4. |
| 3 | If nnpfc_auxiliary_inp_idc is equal to 0, four luma matrices and two chroma matrices are |
| | present in the input tensor, and the number of channels is 6. Otherwise, when |
| | nnpfc_auxiliary_inp_idc is equal to 1, four luma matrices, two chroma matrices, and one |
| | auxiliary input matrix are present in the input tensor, and the number of channels is 7. |
| | The luma channels are derived in an interleaved manner as illustrated in FIG. 4. This |
| | nnpfc_inp_order_idc can only be used when the input chroma format is 4:2:0. |
| 4 . . . 255 | Reserved |

FIG. 4 illustrates an example of deriving luma channels from a luma component. For example, four luma channels (right) are derived from the luma component (left) when nnpfc_inp_order_idc is equal to 3.

nnpfc_inp_tensor_luma_bitdepth_minus8 plus 8 specifies the bit depth of luma sample values in the input integer tensor. The value of inpTensorBitDepthY is derived as follows:

$${inpTensorBitDepth}_{Y} = nnpfc\_inp \_tensor \_luma \_bitdepth \_minus 8 + 8 \qquad ( 85 )$$

It is a requirement of bitstream conformance that the value of nnpfc_inp_tensor_luma_bitdepth_minus8 shall be in the range of 0 to 24, inclusive.

nnpfc_inp_tensor_chroma_bitdepth_minus8 plus 8 specifies the bit depth of chroma sample values in the input integer tensor. The value of inpTensorBitDepthC is derived as follows:

inpTensorBitDepthC=nnpfc_inp_tensor_chroma_bitdepth_minus8+8 (86)

It is a requirement of bitstream conformance that the value of nnpfc_inp_tensor_chroma_bitdepth_minus8 shall be in the range of 0 to 24, inclusive.

When nnpfc_auxiliary_inp_idc is equal to 1, the variable strengthControlScaledVal is derived as follows:

for( i = 0; i < numInputPics; i++ )

| | |
|---|---|
| if( nnpfc_inp_format_idc == 1 ) | (87) |

```
    if( nnpfc_inp_order_idc == 0 || nnpfc_inp_order_idc == 2 ||
        nnpfc_inp_order_idc == 3 )
      strengthControlScaledVal[ i ] =
          Floor ( StrengthControlVal[ i ] * ( ( 1 << inpTensorBitDepth_{Y} ) − 1 ) )
    else if( nnpfc_inp_order_idc == 1 )
      strengthControlScaledVal[ i ] =
          Floor ( StrengthControlVal[ i ] * ( ( 1 << inpTensorBitDepth_{C} ) − 1 ) )
  else
    strengthControlScaledVal[ i ] = StrengthControlVal[ i ]
```

A patch is a rectangular array of samples from a component (e.g., a luma or chroma component) of a picture.

The process DeriveInputTensors( ), for deriving the input tensor inputTensor for a given vertical sample coordinate cTop and a horizontal sample coordinate cLeft specifying the top-left sample location for the patch of samples included in the input tensor, is specified as follows:

```
for( i = 0; i < numInputPics; i++ ) {
  if( nnpfc_inp_order_idc == 0 )
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        inpVal = InpY( InpSampleVal( cTop + yP, cLeft + xP, CroppedHeight,
            CroppedWidth, CroppedYPic[ i ], 0 ) )
        yPovlp = yP + nnpfc_overlap
        xPovlp = xP + nnpfc_overlap
        if( !nnpfc_component_last_flag )
          inputTensor[ 0 ][ i ][ 0 ][ yPovlp ][ xPovlp ] = inpVal
        else
          inputTensor[ 0 ][ i ][ yPovlp ][ xPovlp ][ 0 ] = inpVal
        if( nnpfc_auxiliary_inp_idc == 1 )
          if( !nnpfc_component_last_flag )
            inputTensor[ 0 ][ i ][ 1 ][ yPovlp ][ xPovlp ] = strengthControlScaledVal[ i ]
          else
            inputTensor[ 0 ][ i ][ yPovlp ][ xPovlp ][ 1 ] = strengthControlScaledVal[ i ]
      }
```

| | |
|---|---|
| else if( nnpfc_inp_order_idc == 1 ) | (88) |

```
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        inpCbVal = InpC( InpSampleVal( cTop + yP, cLeft + xP, CroppedHeight / SubHeightC,
            CroppedWidth / SubWidthC, CroppedCbPic[ i ], 1 ) )
        inpCrVal = InpC( InpSampleVal( cTop + yP, cLeft + xP, CroppedHeight / SubHeightC,
            CroppedWidth / SubWidthC, CroppedCrPic[ i ], 2 ) )
        yPovlp = yP + nnpfc_overlap
        xPovlp = xP + nnpfc_overlap
        if( !nnpfc_component_last_flag ) {
          inputTensor[ 0 ][ i ][ 0 ][ yPovlp ][ xPovlp ] = inpCbVal
          inputTensor[ 0 ][ i ][ 1 ][ yPovlp ][ xPovlp ] = inpCrVal
        } else {
          inputTensor[ 0 ][ i ][ yPovlp ][ xPovlp ][ 0 ] = inpCbVal
          inputTensor[ 0 ][ i ][ yPovlp ][ xPovlp ][ 1 ] = inpCrVal
        }
        if( nnpfc_auxiliary_inp_idc == 1 )
          if( !nnpfc_component_last_flag )
            inputTensor[ 0 ][ i ][ 2 ][ yPovlp ][ xPovlp ] = strengthControlScaledVal[ i ]
          else
            inputTensor[ 0 ][ i ][ yPovlp ][ xPovlp ][ 2 ] = strengthControlScaledVal[ i ]
      }
  else if( nnpfc_inp_order_idc == 2 )
    for( yP = −nnpfc_overlap; yP < inpPatchHeight + nnpfc_overlap; yP++)
      for( xP = −nnpfc_overlap; xP < inpPatchWidth + nnpfc_overlap; xP++ ) {
        yY = cTop + yP
        xY = cLeft + xP
        yC = yY / SubHeightC
        xC = xY / SubWidthC
        inpYVal = InpY( InpSampleVal( yY, xY, CroppedHeight,
            CroppedWidth, CroppedYPic[ i ], 0 ) )
        inpCbVal = InpC( InpSampleVal( yC, xC, CroppedHeight / SubHeightC,
            CroppedWidth / SubWidthC, CroppedCbPic[ i ], 1 ) )
        inpCrVal = InpC( InpSampleVal( yC, xC, CroppedHeight / SubHeightC,
            CroppedWidth / SubWidthC, CroppedCrPic[ i ], 2 ) )
        yPovlp = yP + nnpfc_overlap
        xPovlp = xP + nnpfc_overlap
        if( !nnpfc_component_last_flag ) {
          inputTensor[ 0 ][ i ][ 0 ][ yPovlp ][ xPovlp ] = inpYVal
          inputTensor[ 0 ][ i ][ 1 ][ yPovlp ][ xPovlp ] = inpCbVal
          inputTensor[ 0 ][ i ][ 2 ][ yPovlp ][ xPovlp ] = inpCrVal
        } else {
          inputTensor[ 0 ][ i ][ yPovlp ][ xPovlp ][ 0 ] = inpYVal
          inputTensor[ 0 ][ i ][ yPovlp ][ xPovlp ][ 1 ] = inpCbVal
          inputTensor[ 0 ][ i ][ yPovlp ][ xPovlp ][ 2 ] = inpCrVal
        }
        if( nnpfc_auxiliary_inp_idc == 1 )
          if( !nnpfc_component_last_flag )
            inputTensor[ 0 ][ i ][ 3 ][ yPovlp ][ xPovlp ] = strengthControlScaledVal[ i ]
          else
            inputTensor[ 0 ][ i ][ yPovlp ][ xPovlp ][ 3 ] = strengthControlScaledVal[ i ]
      }
  else if( nnpfc_inp_order_idc == 3 )
    for( yP = −nnpfc_overlap; yP < inpPatchHeight + nnpfc_overlap; yP++)
        for( xP = −nnpfc_overlap; xP < inpPatchWidth + nnpfc_overlap; xP++ ) {
        yTL = cTop + yP * 2
        xTL = cLeft + xP * 2
        yBR = yTL + 1
        xBR = xTL + 1
        yC = cTop / 2 + yP
        xC = cLeft / 2 + xP
        inpTLVal = InpY( InpSampleVal( yTL, xTL, CroppedHeight,
            CroppedWidth, CroppedYPic[ i ], 0 ) )
        inpTRVal = InpY( InpSampleVal( yTL, xBR, CroppedHeight,
            CroppedWidth, CroppedYPic[ i ], 0 ) )
        inpBLVal = InpY( InpSampleVal( yBR, xTL, CroppedHeight,
            CroppedWidth, CroppedYPic[ i ], 0 ) )
        inpBRVal = InpY( InpSampleVal( yBR, xBR, CroppedHeight,
            CroppedWidth, CroppedYPic[ i ], 0 ) )
        inpCbVal = InpC( InpSampleVal( yC, xC, CroppedHeight / 2,
            CroppedWidth / 2, CroppedCbPic[ i ], 1 ) )
        inpCrVal = InpC( InpSampleVal( yC, xC, CroppedHeight / 2,
            CroppedWidth / 2, CroppedCrPic[ i ], 2 ) )
        yPovlp = yP + nnpfc_overlap
        xPovlp = xP + nnpfc_overlap
        if( !nnpfc_component_last_flag ) {
          inputTensor[ 0 ][ i ][ 0 ][ yPovlp ][ xPovlp ] = inpTLVal
          inputTensor[ 0 ][ i ][ 1 ][ yPovlp ][ xPovlp ] = inpTRVal
          inputTensor[ 0 ][ i ][ 2 ][ yPovlp ][ xPovlp ] = inpBLVal
          inputTensor[ 0 ][ i ][ 3 ][ yPovlp ][ xPovlp ] = inpBRVal
          inputTensor[ 0 ][ i ][ 4 ][ yPovlp ][ xPovlp ] = inpCbVal
          inputTensor[ 0 ][ i ][ 5 ][ yPovlp ][ xPovlp ] = inpCrVal
        } else {
          inputTensor[ 0 ][ i ][ yPovlp ][ xPovlp ][ 0 ] = inpTLVal
          inputTensor[ 0 ][ i ][ yPovlp ][ xPovlp ][ 1 ] = inpTRVal
          inputTensor[ 0 ][ i ][ yPovlp ][ xPovlp ][ 2 ] = inpBLVal
          inputTensor[ 0 ][ i ][ yPovlp ][ xPovlp ][ 3 ] = inpBRVal
          inputTensor[ 0 ][ i ][ yPovlp ][ xPovlp ][ 4 ] = inpCbVal
          inputTensor[ 0 ][ i ][ yPovlp ][ xPovlp ][ 5 ] = inpCrVal
        }
        if( nnpfc_auxiliary_inp_idc == 1 )
          if( !nnpfc_component_last_flag )
            inputTensor[ 0 ][ i ][ 6 ][ yPovlp ][ xPovlp ] = strengthControlScaledVal[ i ]
          else
            inputTensor[ 0 ][ i ][ yPovlp ][ xPovlp ][ 6 ] = strengthControlScaledVal[ i ]
      }
}
```

nnpfc_out_format_idc equal to 0 indicates that the sample values output by the NNPF are real numbers where the value range of 0 to 1, inclusive, maps linearly to the unsigned integer value range of 0 to (1<<bitDepth)−1, inclusive, for any desired bit depth bitDepth for subsequent post-processing or displaying.

nnpfc_out_format_idc equal to 1 indicates that the luma sample values output by the NNPF are unsigned integer numbers in the range of 0 to (1<<outTensorBitDepthY)−1, inclusive, and the chroma sample values output by the NNPF are unsigned integer numbers in the range of 0 to (1<<<outTensorBitDepthC)−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc.

nnpfc_out_order_idc indicates the output order of samples resulting from the NNPF.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When chromaUpsamplingFlag is equal to 1, nnpfc_out_order_idc shall not be equal to 0 or 3.

When colourizationFlag is equal to 1, nnpfc_out_order_idc shall not be equal to 0.

Table 3 contains an informative description of nnpfc_out_order_idc values.

TABLE 3
Description of nnpfc_out_order_idc values

| nnpfc_out_{—} | |
|---|---|
| order_idc | Description |
| 0 | Only the luma matrix is present in the output |
| | tensor, thus the number of channels is 1. |
| 1 | Only the chroma matrices are present in the |
| | output tensor, thus the number of channels is 2. |
| 2 | The luma and chroma matrices are present in the |
| | output tensor, thus the number of channels is 3. |
| 3 | Four luma matrices and two chroma matrices are |
| | present in the output tensor, thus the number |
| | of channels is 6. This nnpfc_out_order_idc can |
| | only be used when the output chroma format is 4:2:0. |
| 4 . . . 255 | Reserved |

nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive. The value of outTensorBitDepthY is derived as follows:

$${outTensorBitDepth}_{Y} = nnpfc\_out \_tensor \_luma \_bitdepth \_minus 8 + 8 \qquad ( 89 )$$

nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive. The value of outTensorBitDepthC is derived as follows:

$$outTensorBitDepthC = nnpfc\_out \_tensor \_chroma \_bitdepth \_minus 8 + 8 \qquad ( 90 )$$

When bitDepthUpsampimgFlag is equal to 1, the value of nnpfc_out_format_idc shall be equal to 1 and at least one of the following conditions shall be true:
nnpfc_out_tensor_luma_bitdepth_minus8 is present and outTensorBitDepth_{Y} is greater than BitDepth_{Y}.
nnpfc_out_tensor_chroma_bitdepth_minus8 is present and outTensorBitDepth_{C} is greater than BitDepth_{C}.

When nnpfc_inp_tensor_luma_bitdepth_minus8, nnpfc_inp_tensor_chroma_bitdepth_minus8, nnpfc_out_tensor_luma_bitdepth_minus8, and nnpfc_out_tensor_chroma_bitdepth_minus8 are present and outTensorBitDepthY is greater than inpTensorBitDepthY, outTensorBitDepthC shall not be less than inpTensorBitDepthC. When nnpfc_inp_tensor_luma_bitdepth_minus8, nnpfc_inp_tensor_chroma_bitdepth_minus8, nnpfc_out_tensor_luma_bitdepth_minus8, and nnpfc_out_tensor_chroma_bitdepth_minus8 are present and outTensorBitDepthC is greater than inpTensorBitDepthC, outTensorBitDepthY shall not be less than inpTensorBitDepthY.

The process StoreOutputTensors( ), for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
for( i = 0; i < numOutputPics; i++ ) {
  if( nnpfc_out_order_idc == 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfcOutputPicHeight && xY < nnpfcOutputPicWidth )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
```

| | |
|---|---|
| else if( nnpfc_out_order_idc == 1 ) | (91) |

```
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfcOutputPicHeight / outSubHeightC &&
            xSrc < nnpfcOutputPicWidth / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc == 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = ( xP / outSubWidthC ) * outSubWidthC
        if ( yY < nnpfcOutputPicHeight && xY < nnpfcOutputPicWidth )
          if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc == 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfcOutputPicHeight / 2 &&
            xSrc < nnpfcOutputPicWidth / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

nnpfc_separate_colour_description_present_flag equal to 1 indicates that a distinct combination of colour primaries, transfer characteristics, matrix coefficients, and scaling and offset values applied in association with the matrix coefficients for the picture resulting from the NNPF is specified in the SEI message syntax structure. nnpfc_separate_colour_description_present_flag equal to 0 indicates that the combination of colour primaries, transfer characteristics, matrix coefficients, and scaling and offset values applied in association with the matrix coefficients for the picture resulting from the NNPF is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the colour primaries of the picture resulting from applying the NNPF specified in the SEI message, rather than the colour primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the NNPF specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs describes the equations used in deriving luma and chroma signals from the green, blue, and red, or Y, Z, and X primaries. Its semantics apply to the pictures resulting from applying the NNPF specified in this SEI message and are as specified for MatrixCoefficients in Rec. ITU-T H.273|ISO/IEC 23091-2 with BitDepthY and BitDepthC being equal to outTensorBitDepthY and outTensorBitDepthC, respectively.

When nnpfc_matrix_coeffs is not present in the NNPFC SEI message, the value of nnpfc_matrix_coeffs is inferred to be equal to vui_matrix_coeffs.

nnpfc_matrix_coeffs shall not be equal to 0 unless both of the following conditions are true:
nnpfc_out_tensor_chroma_bitdepth_minus8 is equal to nnpfc_out_tensor_luma_bitdepth_minus8.
nnpfc_out_order_idc is equal to 2, outSubHeightC is equal to 1, and outSubWidthC is equal to 1.

nnpfc_matrix_coeffs shall not be equal to 8 unless one of the following conditions is true:
nnpfc_out_tensor_chroma_bitdepth_minus8 is equal to nnpfc_out_tensor_luma_bitdepth_minus8.
nnpfc_out_tensor_chroma_bitdepth_minus8 is equal to nnpfc_out_tensor_luma_bitdepth_minus8+1, nnpfc_out_order_idc is equal to 2, outSubHeightC is equal to 1, and outSubWidthC is equal to 1.

nnpfc_full_range_flag indicates the scaling and offset values applied in association with the matrix coefficients as specified by nnpfc_matrix_coeffs. Its semantics are as specified for the VideoFullRangeFlag parameter in Rec. ITU-T H.273|ISO/IEC 23091-2. When not present, the value of nnpfc_full_range_flag is inferred to be equal to 0.

nnpfc_chroma_loc_info_present_flag equal to 1 indicates the presence of the nnpfc_chroma_sample_loc_type_frame syntax element in the NNPFC SEI message. nnpfc_chroma_loc_info_present_flag equal to 0 indicates the absence of the nnpfc_chroma_sample_loc_type_frame syntax element in the NNPFC SEI message. When colourizationFlag is equal to 0 or nnpfc_out_colour_format_idc is not equal to 1, the value of nnpfc_chroma_loc_info_present_flag shall be equal to 0.

nnpfc_chroma_sample_loc_type_frame, when not equal to 6 and nnpfc_out_colour_format_idc is equal to 1, specifies the location of chroma samples of the output pictures, as shown in FIG. 4. nnpfc_chroma_sample_loc_type_frame equal to 6 and nnpfc_out_colour_format_idc equal to 1 indicates that the location of the chroma samples is unknown or unspecified or specified by other means not specified in this document. The value of nnpfc_chroma_sample_loc_type_frame shall be in the range of 0 to 6, inclusive.

nnpfc_overlap indicates the overlapping horizontal and vertical sample counts of adjacent input tensors of the NNPF. The value of nnpfc_overlap shall be in the range of 0 to 16 383, inclusive.

nnpfc_constant_patch_size_flag equal to 1 indicates that the NNPF accepts exactly the patch size indicated by nnpfc_patch_width_minus1 and nnpfc_patch_height_minus1 as input. nnpfc_constant_patch_size_flag equal to 0 indicates that the NNPF accepts as input any patch size with width inpPatchWidth and height inpPatchHeight such that the width of an extended patch (i.e., a patch plus the overlapping area), which is equal to inpPatchWidth+2*nnpfc_overlap, is a positive integer multiple of nnpfc_extended_patch_width_cd_delta_minus1+1+2*nnpfc_overlap, and the height of the extended patch, which is equal to inpPatchHeight+2*nnpfc_overlap, is a positive integer multiple of nnpfc_extended_patch_height_cd_delta_minus1+1+2*nnpfc_overlap.

nnpfc_patch_width_minus1 plus 1, when nnpfc_constant_patch_size_flag equal to 1, indicates the horizontal sample counts of the patch size required for the input to the NNPF. The value of nnpfc_patch_width_minus1 shall be in the range of 0 to Min(32 766, CroppedWidth−1), inclusive.

nnpfc_patch_height_minus1 plus 1, when nnpfc_constant_patch_size_flag equal to 1, indicates the vertical sample counts of the patch size required for the input to the NNPF. The value of nnpfc_patch_height_minus1 shall be in the range of 0 to Min(32 766, CroppedHeight−1), inclusive.

nnpfc_extended_patch_width_cd_delta_minus1 plus 1 plus 2*nnpfc_overlap, when nnpfc_constant_patch_size_flag equal to 0, indicates a common divisor of all allowed values of the width of an extended patch required for the input to the NNPF. The value of nnpfc_extended_patch_width_cd_delta_minus1 shall be in the range of 0 to Min(32 766, CroppedWidth−1), inclusive.

nnpfc_extended_patch_height_cd_delta_minus1 plus 1 plus 2*nnpfc_overlap, when nnpfc_constant_patch_size_flag equal to 0, indicates a common divisor of all allowed values of the height of an extended patch required for the input to the NNPF. The value of nnpfc_extended_patch_height_cd_delta_minus1 shall be in the range of 0 to Min(32 766, CroppedHeight−1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth+2*nnpfc_overlap shall be a positive integer multiple ofnnpfc_extended_patch_width_cd_delta_minus1+1+2*nnpfc_overlap and inpPatchWidth shall be less than or equal to CroppedWidth. The value of inpPatchHeight+2*nnpfc_overlap shall be a positive integer multiple ofnnpfc_extended_patch_height_cd_delta_minus1+1+2*nnpfc_overlap and inpPatchHeight shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1.

The variables outPatchWidth, outPatchHeight, horCScaling, verCScaling, outPatchCWidth, and outPatchCHeight are derived as follows:

$$outPatchWidth = ( nnpfcOutputPicWidth * inpPatchWidth ) / CroppedWidth \qquad ( 92 )$$

$$outPatchHeight = ( nnpfcOutputPicHeight * inpPatchHeight ) / CroppedHeight \qquad ( 93 )$$

$$horCScaling = SubWidthC / outSubWidthC \qquad ( 94 )$$

$$verCScaling = SubHeightC / outSubHeightC \qquad ( 95 )$$

It is a requirement of bitstream conformance that outPatchWidth*CroppedWidth shall be equal to nnpfcOutputPicWidth*inpPatchWidth and outPatchHeight*CroppedHeight shall be equal to nnpfcOutputPicHeight*inpPatchHeight.

nnpfc_padding_type indicates the process of padding when referencing sample locations outside the boundaries of the input picture as described in Table 4. The value of nnpfc_padding_type shall be in the range of 0 to 4, inclusive, in bitstreams conforming to this edition of this document. Values of 5 to 15, inclusive, for nnpfc_padding_type are reserved for future use by ITU-T|ISO/IEC and shall not be present in bitstreams conforming to this edition of this document. Decoders conforming to this edition of this document shall ignore NNPFC SEI messages with nnpfc_padding_type in the range of 5 to 15, inclusive. Values of nnpfc_padding_type greater than 15 shall not be present in bitstreams conforming to this edition of this document and are not reserved for future use.

TABLE 4
Informative description of nnpfc_padding_type values

| nnpfc_padding_type | Description |
|---|---|
| 0 | Zero padding |
| 1 | Replication padding |
| 2 | Reflection padding |
| 3 | Wrap-around padding |
| 4 | Fixed padding |
| 5 . . . 15 | reserved |

nnpfc_luma_padding_val indicates the luma value to be used for padding when nnpfc_padding_type is equal to 4. The value of nnpfc_luma_padding_val shall be in the range of 0 to (1<<BitDepthY)−1, inclusive.

nnpfc_cb_padding_val indicates the Cb value to be used for padding when nnpfc_padding_type is equal to 4. The value of nnpfc_cb_padding_val shall be in the range of 0 to (1<<BitDepthC)−1, inclusive.

nnpfc_cr_padding_val indicates the Cr value to be used for padding when nnpfc_padding_type is equal to 4. The value of nnpfc_cr_padding_val shall be in the range of 0 to (1<<BitDepthC)−1, inclusive.

The function InpSampleVal(y, x, picHeight, picWidth, croppedPic, cIdx) with inputs being a vertical sample location y, a horizontal sample location x, a picture height picHeight, a picture width picWidth, sample array croppedPic, and component index cIdx (equal to 0 for luma, 1 for Cb, and 2 for Cr) returns the value of sampleVal derived as follows:

NOTE 6—For the inputs to the function InpSampleVal( ), the vertical location is listed before the horizontal location for compatibility with input tensor conventions of some inference engines.

if( nnpfc_padding_type == 0 )
if( y < 0 || x < 0 || y >= picHeight || x >= picWidth )
sampleVal = 0
else

| | |
|---|---|
| sampleVal = croppedPic[ x ][ y ] | (98) |

```
else if( nnpfc_padding_type == 1 )
sampleVal = croppedPic[ Clip3( 0, picWidth − 1, x ) ][ Clip3( 0, picHeight − 1, y ) ]
else if( nnpfc_padding_type == 2 )
sampleVal = croppedPic[ Reflect( picWidth − 1, x ) ][ Reflect( picHeight − 1, y ) ]
else if( nnpfc_padding_type == 3 )
if( y >= 0 && y < picHeight )
  sampleVal = croppedPic[ Wrap( picWidth − 1, x ) ][ y ]
else if( nnpfc_padding_type == 4 )
if( y < 0 || x < 0 || y >= picHeight || x >= picWidth )
  sampleVal = ( cIdx == 0 ? nnpfc_luma_padding_val :
    ( cIdx == 1 ? nnpfc_cb_padding_val : nnpfc_cr_padding_val ) )
else
  sampleVal = croppedPic[ x ][ y ]
```

An NNPF PostProcessingFilter( ) is the target NNPF as derived in the semantics of the NNPFA SEI message. The following example process may be used, with the NNPF PostProcessingFilter( ), to generate, in a patch-wise manner, the filtered and/or interpolated picture(s), which contain Y, Cb, and Cr sample arrays FilteredYPic, FilteredCbPic, and FilteredCrPic, respectively, as indicated by nnpfc_out_order_idc:

```
if( nnpfc_inp_order_idc == 0 || nnpfc_inp_order_idc == 2 )
for( cTop = 0; cTop < CroppedHeight; cTop += inpPatchHeight )
  for( cLeft = 0; cLeft < CroppedWidth; cLeft += inpPatchWidth ) {
    DeriveInputTensors( )
    outputTensor = PostProcessingFilter( inputTensor )
    StoreOutputTensors( )
  }
else if( nnpfc_inp_order_idc == 1 )
for( cTop = 0; cTop < CroppedHeight / SubHeightC; cTop += inpPatchHeight )
  for( cLeft = 0; cLeft < CroppedWidth / SubWidthC; cLeft += inpPatchWidth ) {
```

(99)

```
    DeriveInputTensors( )
    outputTensor = PostProcessingFilter( inputTensor )
    StoreOutputTensors( )
  }
else if( nnpfc_inp_order_idc == 3 )
for( cTop = 0; cTop < CroppedHeight; cTop += inpPatchHeight * 2 )
  for( cLeft = 0; cLeft < CroppedWidth; cLeft += inpPatchWidth * 2 ) {
    DeriveInputTensors( )
    outputTensor = PostProcessingFilter( inputTensor )
    StoreOutputTensors( )
  }
```

An NNPF-generated picture with index i contains sample arrays FilteredYPic[i], FilteredCbPic[i], and FilteredCrPic[i], when present, that are derived by Formula 99. An NNPF-generated picture does not include the overlap regions.

The NNPF process consists of the process defined by Formula 99 followed by outputting NNPF-generated pictures in their increasing index order, where all NNPF-generated pictures that were interpolated by the NNPF are output and those NNPF-generated pictures that correspond to any input pictures to the NNPF are output as specified in the semantics of the NNPFA SEI message.

nnpfc_complexity_info_present_flag equal to 1 specifies that one or more syntax elements that indicate the complexity of the NNPF associated with the nnpfc_id are present. nnpfc_complexity_info_present_flag equal to 0 specifies that no syntax elements that indicates the complexity of the NNPF associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T|ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log 2_parameter_bit_length_minus3 is not present, the neural network does not use parameters of bit length greater than 1.

nnpfc_num_parameters_idc indicates the maximum number of neural network parameters for the NNPF in units of a power of 2 048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T|ISO/JEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows:

$$outPatchCWidth = outPatchWidth * horCScaling \qquad ( 96 )$$

$$outPatchCHeight = outPatchHeight * verCScaling \qquad ( 97 )$$

It is a requirement of bitstream conformance that the number of neural network parameters of the NNPF shall be less than or equal to maxNumParameters.

nnpfc_num_kmac_operations_idc greater than 0 indicates that the maximum number of multiply−accumulate operations per sample of the NNPF is less than or equal to nnpfc_num_kmac_operations_idc*1000. nnpfc_num_kmac_operations_idc equal to 0 indicates that the maximum number of multiply-accumulate operations of the network is unknown. The value of nnpfc_num_kmac_operations_idc shall be in the range of 0 to 232-2, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8 000, rounded up. nnpfc_total_kilobyte_size equal to 0 indicates that the total size required to store the parameters for the neural network is unknown. The value of nnpfc_total_kilobyte_size shall be in the range of 0 to 2³²−2, inclusive.

nnpfc_metadata_extension_num_bits equal to 0 specifies that nnpfc_reserved_metadata_extension is not present. nnpfc_metadata_extension_num_bits greater than 0 specifies the length, in bits, of nnpfc_reserved_metadata_extension. nnpfc_metadata_extension_num_bits shall be equal to 0 in this edition of this document. Values in the range of 1 to 2 048, inclusive, for nnpfc_metadata_extension_num_bits are reserved for future use by ITU-T|ISO/JEC and shall not be present in bitstreams conforming to this edition of this document. Decoders conforming to this edition of this document shall allow any value of nnpfc_metadata_extension_num_bits in the range of 0 to 2048, inclusive. Values of nnpfc_metadata_extension_num_bits greater than 2048 shall not be present in bitstreams conforming to this edition of this document and are not reserved for future use.

nnpfc_reserved_metadata_extension shall not be present in bitstreams conforming to this edition of this document. However, decoders conforming to this edition of this document shall ignore the presence and value of nnpfc_reserved_metadata_extension. When present, the length, in bits, of nnpfc_reserved_metadata_extension is equal to nnpfc_metadata_extension_num_bits.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/fEC 15938-17. The byte sequence nnpfc_payload_byte[i] for all present values of i shall be a complete bitstream that conforms to ISO/fEC 15938-17.

### 8.28.3 Neural-Network Post-Filter Activation SET Message

### 8.28.3.1 Neural-Network Post-Filter Activation SET Message Syntax

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_target_base_flag | u(1) |
| nnpfa_persistence_flag | u(1) |
| nnpfa_num_output_entries | ue(v) |
| for( i = 0; i < nnpfa_num_output_entries; i++ ) | |
| nnpfa_output_flag[ i ] | u(1) |
| } | |
| } | |

### 8.23.8.2 Neural-Network Post-Filter Activation SET Message Semantics

The neural-network post-filter activation (NNPFA) SEI message activates or de-activates the possible use of the target neural-network post-processing filter (NNPF), identified by nnpfa_target_id and nnpfa_target_base_flag, for post-processing filtering of a set of pictures. For a particular picture for which the NNPF is activated, the target NNPF is derived as follows:
If nnpfa_target_base_flag is equal to 1, the target NNPF is the base NNPF with nnpfc_id equal to nnpfa_target_id.
Otherwise (nnpfa_target_base_flag is equal to 0), the target NNPF is the NNPF specified by the last NNPFC SEI message with nnpfc_id equal to nnpfa_target_id that precedes the first VCL NAL unit of the current picture in decoding order and is not a repetition of the NNPFC SEI message that contains the base NNPF.

NOTE—There can be several NNPFA SEI messages present for the same picture, for example, when the NNPFs are meant for different purposes or for filtering of different colour components.

nnpfa_target_id indicates the target NNPF, which is specified by one or more NNPFC SEI messages that pertain to the current picture and have nnpfc_id equal to nnpfa_target_id. The value of nnpfa_target_id shall be in the range of 0 to 2³²−2, inclusive.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target NNPF established by any previous NNPFA SEI message with the same nnpfa_target_id as the current SEI message is cancelled, i.e., the target NNPF is no longer used unless it is activated by another NNPFA SEI message with the same nnpfa_target_id as the current SEI message and nnpfa_cancel_flag equal to 0. nnpfa_cancel_flag equal to 0 indicates that the nnpfa_target_base_flag, nnpfa_persistence_flag, and nnpfa_num_output_entries follow.

nnpfa_target_base_flag equal to 1 specifies that the target NNPF is the base NNPF with nnpfc_id equal to nnpfa_target_id. nnpfa_target_base_flag equal to 0 specifies that the target NNPF is the NNPF specified by the last NNPFC SEI message with nnpfc_id equal to nnpfa_target_id that precedes the first VCL NAL unit of the current picture in decoding order and is not a repetition of the NNPFC SEI message that contains the base NNPF.

nnpfa_persistence_flag specifies the persistence of the target NNPF for the current layer.

nnpfa_persistence_flag equal to 0 specifies that the target NNPF may be used for post-processing filtering for the current picture only.

nnpfa_persistence_flag equal to 1 specifies that the target NNPF may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

NOTE—The target NNPF is not applied for this subsequent picture in the current layer associated with a NNPFA SEI message with the same nnpfa_target_id as the current SEI message and nnpfa_cancel_flag equal to 1.

Let the nnpfcTargetPictures be the set of pictures to which the last NNPFC SEI message with nnpfc_id equal to nnpfa_target_id that precedes the current NNPFA SEI message in decoding order pertains. Let nnpfaTargetPictures be the set of pictures for which the target NNPF is activated by the current NNPFA SEI message. It is a requirement of bitstream conformance that any picture included in nnpfaTargetPictures shall also be included in nnpfcTargetPictures.

nnpfa_num_output_entries specifies the number of nnpfa_output_flag[i] syntax elements present in the NNPFA SEI message. The value of nnpfa_num_output_entries shall be in the range of 0 to NumInpPicsInOutputTensor, inclusive.

nnpfa_output_flag[i] equal to 1 specifies that the NNPF-generated picture that corresponds to the input picture having index InpIdx[i] is output by the NNPF process activated by this NNPFA SEI message, where the NNPF process is specified in the semantics of the NNPFC SEI message. nnpfa_output_flag[i] equal to 0 specifies that the NNPF-generated picture that corresponds to the input picture having index InpIdx[i] is not output by the NNPF process activated by this NNPFA SEI message. When nnpfa_num_output_entries is less than NumInpPicsInOutputTensor, nnpfa_output_flag[i] is inferred to be equal to 1 for each value of i in the range of nnpfa_num_output_entries to NumInpPicsInOutputTensor−1, inclusive.

### D.12.11 Use of the Neural Network Post-Filter Characteristics SEI Message

Let currPic be the cropped decoded output picture for which the neural-network post-processing filter (NNPF) defined by the neural-network post-filter characteristics (NNPFC) SEI message is activated by a neural-network post-filter activation (NNPFA) SEI message and currLayerId be the nuh_layer_id value of currPic.

It is a requirement of bitstream conformance that when a picture unit contains an NNPFA SEI message, the value of ph_pic_output_flag in the picture header contained in that picture unit shall be equal to 1.

NOTE—Since only cropped decoded output pictures are used as input pictures of the NNPF, the value of ph_pic_output_flag in the picture header of the coded picture corresponding to each input picture of the NNPF is equal to 1.

The variable pictureRateUpsamplingFlag is set equal to (nnpfc_purpose & 0x08)!=0.

The variable numInputPics is set equal to nnpfc_num_input_pics_minus1+1.

The variable numInferences is derived as follows:
If pictureRateUpsamplingFlag is equal to 1, the NNPFA SEI message that activated this NNPF has nnpfa_persistence_flag equal to 1, nnpfc_interpolated_pics[i] is greater than 0 only for a single value of i that is greater than 0, and currPic is the last picture of the bitstream in output order that has nuh_layer_id equal to currLayerId, the variable numPostRoll is set equal to the value of i such that nnpfc_interpolated_pics[i] is greater than 0 and the variable numInferences is set equal to 1+numPostRoll.
Otherwise, the variable numInferences is set equal to 1.

For each value of j in the range of 0 to numInferences−1, inclusive, the following applies:
The arrays inputPic[i] and inputPresentFlag[i] for i in the range of 0 to numInputPics−1, inclusive, representing all the input pictures and the presence of input pictures within the bitstream, respectively, are specified as follows:
   When j is greater than 0, for each value of k in the range of 0 to j−1, inclusive, inputPic[k] is set to be currPic and inputPresentFlag[k] is set equal to 0.
   The j-th input picture, inputPic[j], is set equal to be currPic and inputPresentFlag[j] is set equal to 1.
   When numInputPics is greater than 1, the following applies for each value of i in the range of j+1 to numInputPics-j−1, inclusive, in increasing order of i:
      If pictureRateUpsamplingFlag is equal to 1, currPic is associated with a frame packing arrangement SEI message with fp_arrangement_type equal to 5 and a particular value of fp_current_frame_is_frame0 flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with fp_arrangement_type equal to 5 and the same value of fp_current_frame_is_frame0 flag, inputPic[i] is set to be prevPic and inputPresentFlag[i] is set equal to 1.
      Otherwise, if pictureRateUpsamplingFlag is equal to 0 and there is a picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, if currPic is not associated with a frame packing arrangement SEI message with fp_arrangement_type equal to 5 and there is a cropped decoded output picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, the following applies:
         inputPic[i] is set to be the same picture as inputPic[i−1] and inputPresentFlag[i] is set equal to 0.
         It is a requirement of bitstream conformance that num_interpolated_pics[i−1] shall not be greater than 0.
For purposes of interpretation of the NNPFC SEI message, the following variables are specified:
   If numInputPics is greater than 1 and there is a second NNPF that is defined by at least one NNPFC SEI message, is activated by an NNPFA SEI message for currPic, and has nnpfc_purpose equal to 4, the following applies:
      CroppedWidth is set equal to nnpfc_pic_width_in_luma_samples defined for the second NNPF.
      CroppedHeight is set equal to nnpfc_pic_height_in_luma_samples defined for the second NNPF.
   Otherwise, the following applies:
      CroppedWidth is set equal to the value of pps_pic_width_in_luma_samples−SubWidthC*(pps_conf_win_left_offset+pps_conf_win_right_offset) for currPic.
      CroppedHeight is set equal to the value of pps_pic_height_in_luma_samples−SubHeightC*(pps_conf_win_top_offset+pps_conf_win_bottom_offset) for currPic.
   The luma sample arrays CroppedYPic[i] and the chroma sample arrays CroppedCbPic[i] and CroppedCrPic[i], when present, are derived as follows for each value of i in the range of 0 to numInputPics−1, inclusive:
      The variable sourcePic is derived as follows:
         If inputPresentFlag[i] is equal to 1 or nnpfc_absent_input_pic_zero_flag is equal to 0, sourcePic is set to be inputPic[i].
         Otherwise(inputPresentFlag[i] is equal to 0 and nnpfc_absent_input_pic_zero_flag is equal to 1), sourcePic is set to be a picture with a luma sample array of CroppedWidth×CroppedHeight samples equal to 0 and Cb and Cr sample arrays of (CroppedWidth/SubWidthC)×(CroppedHeight/SubHeightC) samples equal to 0.
      If numInputPics is equal to 1, the following applies:
         The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of sourcePic.
      Otherwise (numInputPics is greater than 1), the following applies:
         The variable sourceWidth is set equal to the value of pps_pic_width_in_luma_samples−SubWidthC*(pps_conf_win_left_offset+pps_conf_win_right_offset) for sourcePic.
         The variable sourceHeight is set equal to the value of pps_pic_height_in_luma_samples−SubHeightC*(pps_conf_win_top_offset+pps_conf_win_bottom_offset) for sourcePic.
         If sourceWidth is equal to CroppedWidth and sourceHeight is equal to CroppedHeight, inputPic is set to be the same as sourcePic.
         Otherwise (sourceWidth is not equal to CroppedWidth or sourceHeight is not equal to CroppedHeight), the following applies:
         There shall be an NNPF, hereafter referred to as the super resolution NNPF, that is defined by at least one NNPFC SEI message, is activated by an NNPFA SEI message for sourcePic, and has nnpfc_purpose equal to 4, nnpfc_pic_width_in_luma samples equal to CroppedWidth and nnpfc_pic_height_in_luma_samples equal to CroppedHeight.
         resampledPic is set to be the output of the neural-network inference of the super resolution NNPF with sourcePic being an input.
         The luma sample array CroppedYPic[i] and the chroma sample arrays CroppedCbPic[i] and CroppedCrPic[i], when present, are set to be the 2-dimensional arrays of decoded sample values of the Y, Cb and Cr components, respectively, of resampledPic.
   BitDepth_{Y} and BitDepth_{C} are both set equal to BitDepth.
   ChromaFormatIdc is set equal to sps_chroma_format_idc.
   The array StrengthControlVal[i] for all values of i in the range of 0 to numInputPics−1, inclusive, specifying the filtering strength control value for the input pictures for the NNPF, is derived as follows:
      StrengthControlVal[i] is set equal to the value of (firstSliceQpy+QpBdOffset)+(63+QpBdOffset), where firstSliceQpy is equal to SliceQpy of the first slice of inputPic[i].

There shall not be more than two NNPFC SEI messages present in a picture unit with the same value of nnpfc_id. When there are two NNPFC SEI messages present in a picture unit with the same value of nnpfc_id, these SEI messages shall have different content. When two NNPFC SEI messages with the same nnpfc_id and different content are present in the same picture unit, both of these NNPFC SEI messages shall be in the same SEI NAL unit.

### 4. Technical Problems Solved by Disclosed Technical Solutions

An example design for the neural-network post-filter SEI message has the following problems:

First, when the NNPF purpose includes picture rate upsampling, the example design of NNPF SEI messages and their interface can avoid output of a picture before the first picture in the bitstream, however for other cases, e.g. multiple input pictures without picture rate upsampling, output of a picture before the first picture in the bitstream is still possible, which is not preferred. Furthermore, while it is good to enable outputting of a picture before the first picture in an CLVS that is not the first CLVS in the bitstream when the NNPF purpose includes picture rate upsampling, this is not preferred in the cases of multiple input pictures without picture rate upsampling.

Second, when the NNPF purpose includes picture rate upsampling, the example design of NNPF SEI messages and their interface may continue NNPF inference until the end of a CLVS, however for other cases, e.g. multiple input pictures without picture rate upsampling, it is also preferred to continue the inference, which is not supported in the current design.

Third, in the example design, the output time instance of a new picture generated by a NNPF that includes picture rate upsampling is not defined, which may lead to undesired multiple times of output between two consecutive input pictures.

Fourth, in the example design, for an NNPF that does not include picture rate upsampling, it is possible that there are multiple output pictures in one inference instance, which is not a common case.

### 5. A Listing of Solutions and Embodiments

To solve the above-described problems, methods as summarized below are disclosed. The aspects should be considered as examples to explain the general concepts and should not be interpreted in a narrow way. Furthermore, these examples can be applied individually or combined in any manner.
1) To solve problem 1, output of a picture before the first picture in a bitstream is not allowed regardless of the NNPF purpose.
   a. Alternatively, output of a picture before the first picture in a CLVS is not allowed for an NNPF with multiple input pictures and an NNPF purpose not including picture rate upsampling.
   b. In one example, it is a requirement of bitstream conformance that, when numInputPics is greater than 1 and inputPic[i] is the first picture in output order in the current bitstream, nnpfc_input_pic_output_flag[i] shall be equal to 0.
      i. Alternatively, it is required that, when numInputPics is greater than 1, the value of nnpfa_output_flag[j] shall be equal to 0 for the corresponding input picture i that is the first picture in output order in the current bitstream, wherein j has the value such that InpIdx[j] is equal to i.
   c. In one example, it is required that nnpfc_input_pic_output_flag[i] shall be equal to 0 for an input picture i with inputPresentFlag[i] equal to 0.
      i. Alternatively, it is required that the value of nnpfa_output_flag[j] shall be equal to 0 for the corresponding input picture i with inputPresentFlag[i] equal to 0, wherein j has the value such that InpIdx[j] is equal to i.
2) To solve problem 2, when an NNPF with multiple input pictures and an NNPF purpose not including picture rate upsampling is activated with nnpfa_persistence_flag equal to 1 and the NNPF is not deactivated for the last picture lastPic in output order in the bitstream, when the current picture is lastPic, the inference of the NNPF is repeated until the picture corresponding to lastPic is generated by the NNPF.
   a. In one example, it is specified that, if pictureRateUpsamplingFlag is equal to 0 and numInputPics is greater than 1, the NNPFA SEI message that activated this NNPF has nnpfa_persistence_flag equal to 1, nnpfc_input_pic_output_flag[i] is equal to 1 for a single value of i that is greater than 0, and currPic is the last picture of the bitstream in output order that has nuh_layer_id equal to currLayerId, the variable numPostRoll is set equal to the value of i such that nnpfc_input_pic_output_flag[i] is equal to 1, and the variable numInferences is set equal to 1+numPostRoll.
   b. Alternatively, in the above items 2 and 2.a, the lastPic is the last picture in output order in the CLVS.
3) To solve problem 3, the following constraint is specified: When pictureRateUpsamplingFlag is equal to 1 for an NNPF, the NNPFA SEI message that activated this NNPF has nnpfa_persistence_flag equal to 1, it is a requirement of bitstream conformance that nnpfc_interpolated_pics[i] is greater than 0 only for a single value of i in the range of 0 to numInputPics−1, inclusive.
   a. Alternatively, it is clarified that: When pictureRateUpsamplingFlag is equal to 1 for an NNPF and the NNPFA SEI message that activated this NNPF has nnpfa_persistence_flag equal to 1, the value of nnpfc_interpolated_pics[i] is greater than 0 only for a single value of i that is greater than 0, otherwise the constraint on at most one picture being output for any particular output time would be violated.
4) To solve problem 3, alternatively, a constraint is specified to disallow generating new pictures more than once between any two consecutive pictures in output order in a bitstream, i.e., the value of nnpfc_interpolated_pics[i] for any value of i in the range of 0 to numInputPics−1, inclusive, is required to be less than or equal to 1.
   a. Alternatively, a constraint is specified to disallow generating new pictures more than once between any two consecutive pictures in output order in a CLVS, i.e., the value of nnpfc_interpolated_pics[i] for any value of i in the range of 0 to numInputPics−1, inclusive, is required to be less than or equal to 1.
   b. Alternatively, the following constraint is specified: For a particular NNPF for which the NNPF purpose includes picture rate upsampling, when the NNPF is activated for more than one picture in the bitstream, for any pair of consecutive pictures in output order in the bitstream, at most one of the activations is allowed to interpolate pictures between that pair of consecutive pictures.
5) To solve problem 3, alternatively, the output time instance of a generated picture during picture rate upsampling is specified.
   a. In one example, the generated pictures between two consecutive input pictures during picture rate upsampling is assumed to be uniformly located between those two input pictures and the output time instance of each generated picture is derived accordingly.
   b. In one example, the output time instance of a generated picture during picture rate upsampling may be indicated by one or more syntax elements.
      i. In one example, a delta value of picture order count (POC) is signalled by one or more syntax elements for each generated picture to indicate its POC relative to POC of the previous input or generated picture during picture rate upsampling.
         1. When the syntax element(s) are not present, the output time instance of a particular generated picture may be inferred.
      ii. In one example, alternatively, a delta value of picture order count (POC) is signalled by one or more syntax elements for each generated picture to indicate its POC relative to the POC of the input picture that is the closest to and succeed the generated picture in output order.
6) To solve problem 4, it should be constrained that when pictureRateUpsamplingFlag is equal to 0, nnpfc_input_pic_output_flag[i] shall be equal to 1 for at least and only one value of i in the range of 0 to nnpfc_num_input_pics_minus1, inclusive.
7) To solve problem 3, alternatively, a constraint is specified to disallow generating NNPF output pictures between any particular pair of consecutive input pictures more than once.
   a. In one example, the following constraint is specified: For any particular pair of pictures inputPicA and inputPicB consecutive in output order in CroppedDecodedPictures, when there are one or more pictures interploatedPicSetA in ListNnpfOutputPics between inputPicA and inputPicB in output order, the pictures in interploatedPicSetA shall belong to the pictures that were output by applying a particular NNPF nnpfA with pictureRateUpsamplingFlag equal to 1 when a particular picture currPicA in CroppedDecodedPictures is the current picture.
      i. In one example, additionally, the application of any other NNPF when currPicA is the current picture or the application of any NNPF (including nnpfA) when another picture currPicB in CroppedDecodedPictures is the current picture shall not output any picture between the inputPicA and inputPicB in output order.

### 6. Embodiments

Below are some example embodiments for the aspects summarized above in Section 5.

Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. It should be understood that only markings in this section are intended to represent text changes. It should be understood that only markings in this section are intended to represent text changes.

### 6.1 Embodiment 1

This embodiment is for item 1 and 1.b as summarized above in Section 5.

### D.12.11 Use of the Neural Network Post-Filter Characteristics SEI Message

. . .

For each value of j in the range of 0 to numInferences−1, inclusive, the following applies:
The arrays inputPic[i] and inputPresentFlag[i] for i in the range of 0 to numInputPics−1, inclusive, representing all the input pictures and the presence of input pictures within the bitstream, respectively, are specified as follows:
   When j is greater than 0, for each value of k in the range of 0 to j−1, inclusive, inputPic[k] is set to be currPic and inputPresentFlag[k] is set equal to 0.
   The j-th input picture, inputPic[j], is set equal to be currPic and inputPresentFlag[j] is set equal to 1.
   When numInputPics is greater than 1, the following applies for each value of i in the range of j+1 to numInputPics {{−j}}−1, inclusive, in increasing order of i:
      If pictureRateUpsamplingFlag is equal to 1, currPic is associated with a frame packing arrangement SEI message with fp_arrangement_type equal to 5 and a particular value of fp_current_frame_is_frame0 flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with fp_arrangement_type equal to 5 and the same value of fp_current_frame_is_frame0 flag, inputPic[i] is set to be prevPic and inputPresentFlag[i] is set equal to 1.
      Otherwise, if pictureRateUpsamplingFlag is equal to 0 and there is a picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, if currPic is not associated with a frame packing arrangement SEI message with fp_arrangement_type equal to 5 and there is a cropped decoded output picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, the following applies:
         inputPic[i] is set to be the same picture as inputPic[i−1] and inputPresentFlag[i] is set equal to 0.
         It is a requirement of bitstream conformance that num_interpolated_pics[i−1] shall not be greater than 0.
         It is a requirement of bitstream conformance that, when inputPic[i] is the first picture in output order in the current bitstream, nnpfc_input_pic_output_flag[i] shall be equal to 0.

. . .

### 6.2 Embodiment 2

This embodiment is for item 1 and 1.c as summarized above in Section 5.

### D.12.11 Use of the Neural Network Post-Filter Characteristics SEI Message

. . .

For each value of j in the range of 0 to numInferences−1, inclusive, the following applies:
The arrays inputPic[i] and inputPresentFlag[i] for i in the range of 0 to numInputPics−1, inclusive, representing all the input pictures and the presence of input pictures within the bitstream, respectively, are specified as follows:
   When j is greater than 0, for each value of k in the range of 0 to j−1, inclusive, inputPic[k] is set to be currPic and inputPresentFlag[k] is set equal to 0.
   The j-th input picture, inputPic[j], is set equal to be currPic and inputPresentFlag[j] is set equal to 1.
   When numInputPics is greater than 1, the following applies for each value of i in the range ofj+1 to numInputPics {{−j}}−1, inclusive, in increasing order of i:
      If pictureRateUpsamplingFlag is equal to 1, currPic is associated with a frame packing arrangement SEI message with fp_arrangement_type equal to 5 and a particular value of fp_current_frame_is_frame0 flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with fp_arrangement_type equal to 5 and the same value of fp_current_frame_is_frame0 flag, inputPic[i] is set to be prevPic and inputPresentFlag[i] is set equal to 1.
      Otherwise, if pictureRateUpsamplingFlag is equal to 0 and there is a picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, if currPic is not associated with a frame packing arrangement SEI message with fp_arrangement_type equal to 5 and there is a cropped decoded output picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, the following applies:
         inputPic[i] is set to be the same picture as inputPic[i−1] and inputPresentFlag[i] is set equal to 0.
         It is a requirement of bitstream conformance that num_interpolated_pics[i−1] shall not be greater than 0.
         It is a requirement of bitstream conformance that, when inputPresentFlag[i] is equal to 0, nnpfc_input_pic_output_flag[i] shall be equal to 0.

### 6.3 Embodiment 3

This embodiment is for item 2 and 2.a as summarized above in Section 5.

### D.12.11 Use of the Neural Network Post-Filter Characteristics SEI Message

. . .

The variable numInferences is derived as follows:
If pictureRateUpsamplingFlag is equal to 1, the NNPFA SEI message that activated this NNPF has nnpfa_persistence_flag equal to 1, nnpfc_interpolated_pics[i] is greater than 0 only for a single value of i that is greater than 0, and currPic is the last picture of the bitstream in output order that has nuh_layer_id equal to currLayerId, the variable numPostRoll is set equal to the value of i such that nnpfc_interpolated_pics[i] is greater than 0 and the variable numInferences is set equal to 1+numPostRoll.
Otherwise, if pictureRateUpsamplingFlag is equal to 0 and numInputPics is greater than 1, the NNPFA SEI message that activated this NNPF has nnpfa_persistence_flag equal to 1, nnpfc_input_pic_output_flag[i] is equal to 1 for a single value of i that is greater than 0, and currPic is the last picture of the bitstream in output order that has nuh_layer_id equal to currLayerId, the variable numPostRoll is set equal to the value of i such that nnpfc_input_pic_output_flag[i] is equal to 1, and the variable numInferences is set equal to 1+numPostRoll.
Otherwise, the variable numInferences is set equal to 1.

For each value of j in the range of 0 to numInferences−1, inclusive, the following applies:
The arrays inputPic[i] and inputPresentFlag[i] for i in the range of 0 to numInputPics−1, inclusive, representing all the input pictures and the presence of input pictures within the bitstream, respectively, are specified as follows:
   When j is greater than 0, for each value of k in the range of 0 to j−1, inclusive, inputPic[k] is set to be currPic and inputPresentFlag[k] is set equal to 0.
   The j-th input picture, inputPic[j], is set equal to be currPic and inputPresentFlag[j] is set equal to 1.
   When numInputPics is greater than 1, the following applies for each value of i in the range of j+1 to numInputPics {{−j}}−1, inclusive, in increasing order of i:
      If pictureRateUpsamplingFlag is equal to 1, currPic is associated with a frame packing arrangement SEI message with fp_arrangement_type equal to 5 and a particular value of fp_current_frame_is_frame0 flag, and there is a cropped decoded output picture prevPic that is the last picture in output order among all cropped decoded output pictures that have nuh_layer_id equal to currLayerId, precede inputPic[i−1] in output order, and are associated with a frame packing arrangement SEI message with fp_arrangement_type equal to 5 and the same value of fp_current_frame_is_frame0 flag, inputPic[i] is set to be prevPic and inputPresentFlag[i] is set equal to 1.
      Otherwise, if pictureRateUpsamplingFlag is equal to 0 and there is a picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, if currPic is not associated with a frame packing arrangement SEI message with fp_arrangement_type equal to 5 and there is a cropped decoded output picture prevPic that is the last picture in output order among all cropped decoded output pictures that have nuh_layer_id equal to currLayerId and precede inputPic[i−1] in output order, inputPic[i] is set to be prevPic and inputPresentFlag[i] is set equal to 1.
      Otherwise, the following applies:
         inputPic[i] is set to be the same picture as inputPic[i−1] and inputPresentFlag[i] is set equal to 0.
         It is a requirement of bitstream conformance that num_interpolated_pics[i−1] shall not be greater than 0.

. . .

### 6.4 Embodiment 4

This embodiment is for item 3 as summarized above in Section 5.

### 8.28.2.2 Neural-Network Post-Filter Characteristics SEI Message Semantics

. . .

nnpfc_interpolated_pics[i] specifies the number of interpolated pictures generated by the NNPF between the i-th and the (i+1)-th picture used as input for the NNPF. The value of nnpfc_interpolated_pics[i] shall be in the range of 0 to 63, inclusive. The value of nnpfc_interpolated_pics[i] shall be greater than 0 for at least one value of i in the range of 0 to nnpfc_num_inputpics_minus1−1, inclusive.

When pictureRateUpsamplingFlag is equal to 1 for an NNPF and the NNPFA SEI message that activated this NNPF has nnpfa_persistence_flag equal to 1, it is a requirement of bitstream conformance that nnpfc_interpolated_pics[i] is greater than 0 only for a single value of i in the range of 0 to numInputPics−1, inclusive.

. . .

### 6.5 Embodiment 5

This embodiment is for item 4.b as summarized above in Section 5.

### 8.28.2.2 Neural-Network Post-Filter Characteristics SEI Message Semantics

Let currPic be the cropped decoded output picture for which the neural-network post-processing filter (NNPF) defined by the neural-network post-filter characteristics (NNPFC) SEI message is activated by a neural-network post-filter activation (NNPFA) SEI message and currLayerId be the nuh_layer_id value of currPic.

It is a requirement of bitstream conformance that when a picture unit contains an NNPFA SEI message, the value of ph_pic_output_flag in the picture header contained in that picture unit shall be equal to 1.
NOTE—Since only cropped decoded output pictures are used as input pictures of the NNPF, the value of ph_pic_output_flag in the picture header of the coded picture corresponding to each input picture of the NNPF is equal to 1.

The variable pictureRateUpsamplingFlag is set equal to (nnpfc_purpose & 0x08)!=0.

For a particular NNPF with pictureRateUpsamplingFlag equal to 1, when the NNPF is activated for more than one picture in the bitstream, for any pair of consecutive pictures in output order in the bitstream, at most one of the activations is allowed to interpolate pictures between that pair of consecutive pictures.

. . .

### 6.6 Embodiment 6

This embodiment is for item 6 as summarized above in Section 5.

### 8.28.2.2 Neural-Network Post-Filter Characteristics SEI Message Semantics

. . .

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture. When nnpfc_num_input_pics_minus1 is equal to 0, nnpfc_input_pic_output_flag[0] is inferred to be equal to 1. When pictureRateUpsamplingFlag is equal to 0 and nnpfc_num_input_pics_minus1 is greater than 0, nnpfc_input_pic_output_flag[i] shall be equal to 1 for at least and only one value of i in the range of 0 to nnpfc_num_input_pics_minus1, inclusive.

. . .

### 6.7 Embodiment 7

This embodiment is for item 7 as summarized above in Section 5.

### 8.28.1 General Post-Processing Filtering Process Using NNPFs

### 8.28.1.1 General

Input to this process is a bitstream BitstreamToFilter. Output of this process is a list of NNPF output pictures ListNnpfOutputPics.

First, BitstreamToFilter is decoded, and the list CroppedDecodedPictures is set to be the list of the cropped decoded pictures in output order resulted from decoding BitstreamToFilter.

Second, the filtering process for one picture, as specified in subclause 8.28.1.2, is repeatedly invoked, in output order, for each cropped decoded picture that is in CroppedDecodedPictures and for which one or more NNPFs are activated.

The order of the pictures in ListNnpfOutputPics is in output order.

Within ListNnpfOutputPics there shall be no more than one picture pertaining to any particular output time instance. When for any particular picture in CroppedDecodedPictures there are multiple NNPFs activated and only one the NNPFs is allowed to be chosen to be applied although any of the NNPFs may be chosen, the above constraint shall apply regardless of which NNPF is chosen to be applied to the particular picture.

For any particular pair of pictures inputPicA and inputPicB consecutive in output order in CroppedDecodedPictures, when there are one or more pictures interploatedPicSetA in ListNnpfOutputPics between inputPicA and inputPicB in output order, the pictures in interploatedPicSetA shall belong to the pictures that were output by applying a particular NNPF nnpfA with pictureRateUpsamplingFlag equal to 1 when a particular picture currPicA in CroppedDecodedPictures is the current picture. The application of any other NNPF when currPicA is the current picture or the application of any NNPF (including nnpfA) when another picture currPicB in CroppedDecodedPictures is the current picture shall not output any picture between the inputPicA and inputPicB in output order.

### 8.28.1.2 Filtering Process for One Picture Using an NNPF

The filtering process specified in this subclause applies to each cropped decoded picture, referred to as the current picture, that is in CroppedDecodedPictures and for which one or more NNPFs are activated.

When applying an NNPF to the current picture, the filtered and/or interpolated pictures are generated by the NNPF by applying the NNPF process specified in the semantics of the NNPFC SEI message, in a patch-wise manner, to the current picture.

When applying an NNPF to the current picture, the order of the pictures generated by the NNPF by applying the NNPF process being stored into the output tensor of the NNPF is in output order.

When the applied NNPF is the last NNPF that is applied to the current picture, the pictures generated by the NNPF and output by the NNPF process are included into ListNnpfOutputPics, in the same order as when the pictures are stored into the output tensor of the NNPF.

More details of the embodiments of the present disclosure will be described below which are related to neural-network post-processing filter. As used herein, the term “neural-network post-processing filter” and “neural-network post-filter” may be used interchangeably. The embodiments of the present disclosure should be considered as examples to explain the general concepts and should not be interpreted in a narrow way. Furthermore, these embodiments can be applied individually or combined in any manner.

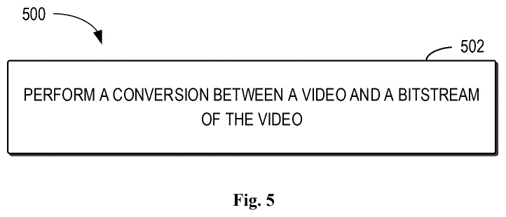

FIG. 5 illustrates a flowchart of a method 500 for video processing in accordance with some embodiments of the present disclosure. As shown in FIG. 5, at 502, a conversion between a video and a bitstream of the video is performed. In some embodiments, the conversion may include encoding the video into the bitstream. Alternatively or additionally, the conversion may include decoding the video from the bitstream.

Moreover, a neural-network post-processing filter (NNPF) is applied on a current picture associated with the video based on at least one input picture for the NNPF. In one example embodiment, the input picture may comprise the current picture. Additionally or alternatively, the input picture may comprise one or more pictures following and/or preceding the current picture. In some embodiments, the current picture may be a decoded picture of the video. Alternatively, the current picture may be a cropped decoded picture of the video. For example, the decoded picture and/or the cropped decoded picture may be outputted by a decoder that decodes the video from the bitstream. In some further embodiments, the current picture may comprise an output of a further NNPF used to filter one or more decoded pictures or cropped decoded pictures of the video. For example, the NNPF is concatenated with the further NNPF. It should be understood that the possible implementations of the current picture associated with the video described here are merely illustrative and therefore should not be construed as limiting the present disclosure in any way.

In addition, a generation of at least one NNPF output picture is performed no more than once between any particular pair of consecutive input pictures. That is, a constraint may be specified to disallow generating NNPF output pictures between any particular pair of consecutive input pictures more than once. For example, no NNPF output picture may be generated between any particular pair of consecutive input pictures. Alternatively, a generation of at least one NNPF output picture may be performed only once between any particular pair of consecutive input pictures. In this case, during the single generating operation, one or more output pictures may be generated by the NNPF.

In some embodiments, for any particular pair of pictures consecutive in an output order in a list of decoded pictures in the output order resulted from decoding the bitstream, if there are one or more pictures in a list of NNPF output pictures that are between the particular pair of pictures in the output order, the one or more pictures are among pictures that are output by applying a particular NNPF with a purpose comprising picture rate upsampling when a first picture in the list of decoded pictures is the current picture.

For example, the list of decoded pictures may comprise at least one decoded picture, at least one cropped decoded picture of the video, and/or the like. By way of example, the list of decoded pictures may be denoted as CroppedDecodedPictures, and the list of NNPF output pictures may be denoted as ListNnpfOutputPics. Moreover, information regarding whether a purpose of NNPF comprises picture rate upsampling may be indicated by an indication PictureRateUpsamplingFlag. The indication PictureRateUpsamplingFlag equal to 0 indicates that the purpose of the NNPF does not comprise picture rate upsampling, and the indication PictureRateUpsamplingFlag equal to 1 indicates that the purpose of the NNPF comprises picture rate upsampling.

By way of example, it may be specified that: for any particular pair of pictures inputPicA and inputPicB consecutive in output order in CroppedDecodedPictures, when there are one or more pictures interpolatedPicSetA in ListNnpfOutputPics between inputPicA and inputPicB in output order, the pictures in interpolatedPicSetA shall be among the pictures that were output by applying a particular NNPF nnpfA with PictureRateUpsamplingFlag equal to 1 when a particular picture currPicA in CroppedDecodedPictures was the current picture. It should be understood that the above illustrations are described merely for purpose of description. The scope of the present disclosure is not limited in this respect.

In addition, at least one of the following do not output any picture between the particular pair of pictures in the output order: an application of any NNPF that is different from the particular NNPF and used in a filtering process for one picture when the first picture is the current picture, or an application of any NNPF that is used in a filtering process for one picture when a second picture in the list of decoded pictures is the current picture, the second picture being different from the first picture.

By way of example rather than limitation, the current picture may be a cropped decoded output picture for which an NNPF defined by the neural-network post-filter characteristics (NNPFC) supplemental enhancement information (SEI) message is activated by a neural-network post-filter activation (NNPFA) SEI message.

By way of example, it may be specified that: the application of any other NNPF that was used in the filtering process for one picture when currPicA was the current picture or the application of any NNPF (including nnpfA) that was used in the filtering process for one picture when any other picture currPicB in CroppedDecodedPictures was the current picture shall not output any picture between the inputPicA and inputPicB in output order. It should be understood that the above illustrations are described merely for purpose of description. The scope of the present disclosure is not limited in this respect.

In view of the above, it is specified that a generation of at least one NNPF output picture is performed no more than once between any particular pair of consecutive input pictures. Compared with the conventional solution lacking such a constraint, the proposed method can advantageously avoid multiple output pictures in one NNPF inference instance. Thereby, a proper functionality of NNPF can be ensured.

In some embodiments, if a purpose of an NNPF comprises picture rate upsampling and the NNPF is allowed to be used for post-processing filtering for the current picture and all subsequent pictures of a current layer in an output order until a condition is met, one or more interpolated pictures are generated only between one pair of consecutive input pictures for the NNPF. For example, the current layer may be a layer comprising the current picture.

As described above, an indication PictureRateUpsamplingFlag may be used to indicate whether the purpose of the NNPF comprises picture rate upsampling or not. Furthermore, an indication nnpfa_persistence_flag may indicate whether the NNPF is allowed to be used for post-processing filtering for the current picture and all subsequent pictures of the current layer in the output order until the condition is met. By way of example, the indication nnpfa_persistence_flag equal to 0 specifies that the target NNPF may be used for post-processing filtering for the current picture only. The indication nnpfa_persistence_flag equal to 1 specifies that the target NNPF may be used for post-processing filtering for the current picture and all subsequent pictures of the current layer in output order until one or more of the following conditions are true:
A new CLVS of the current layer begins.
The bitstream ends.
A picture in the current layer associated with an NNPFA SEI message with the same nnpfa_target_id as the current SEI message is output that follows the current picture in output order.

In one example embodiment, a constraint may be specified that: when PictureRateUpsamplingFlag is equal to 1 for an NNPF and the NNPFA SEI message that activated this NNPF has nnpfa_persistence_flag equal to 1, only for a single value of i in the range of 0 to numInputPics−1, inclusive, the value of nnpfc_interpolated_pics[i] is greater than 0. The variable nnpfc_interpolated_pics[i] specifies the number of interpolated pictures generated by the NNPF between the k-th and the (i+1)-th input picture for the NNPF, and the variable numInputPics specifies the number of pictures used as input for the NNPF. It should be understood that the above illustrations are described merely for purpose of description. The scope of the present disclosure is not limited in this respect.

In some embodiments, a generation of at least one new picture is performed no more than once between any two consecutive pictures in an output order in the bitstream. For example, it may be specified that the value of nnpfc_interpolated_pics[i] for any value of i in the range of 0 to numInputPics−1, inclusive, is required to be less than or equal to 1. Alternatively, a generation of at least one new picture is performed no more than once between any two consecutive pictures in an output order in a coded layer video sequence (CLVS) in the bitstream. For example, it may be specified that the value of nnpfc_interpolated_pics[i] for any value of i in the range of 0 to numInputPics−1, inclusive, is required to be less than or equal to 1. In some further embodiments, for an NNPF with a purpose comprising picture rate upsampling, if the NNPF is activated for more than one picture in the bitstream, for any pair of consecutive pictures in an output order in the bitstream, at most one of the activations of the NNPF is allowed to interpolate pictures between that pair of consecutive pictures.

In some embodiments, an output time instance of each of at least one generated picture during picture rate upsampling is specified. In one example embodiment, the output time instance of each of the at least one generated picture is determined based on that the at least one generated picture between two consecutive input pictures during picture rate upsampling is uniformly located between the two consecutive input pictures.

By way of example, the output time instance of each of the at least one generated picture during picture rate upsampling is indicated based on one or more syntax elements. For example, the one or more syntax elements indicate a difference between a picture order count (POC) of each of the at least one generated picture and a POC of a previous input picture or a previous generated picture. Alternatively, the one or more syntax elements indicate a difference between a POC of each of the at least one generated picture and a POC of a reference input picture that is the first input picture following that generated picture in the output order. In addition, or alternatively, if the one or more syntax elements are absent from the bitstream, the output time instance of each of the at least one generated picture is inferred.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between a video and a bitstream of the video is performed. A neural-network post-processing filter (NNPF) is applied on a current picture associated with the video based on at least one input picture for the NNPF, and a generation of at least one NNPF output picture is performed no more than once between any particular pair of consecutive input pictures.

According to still further embodiments of the present disclosure, a method for storing bitstream of a video is provided. In the method, the bitstream is generated from the video, and stored in a non-transitory computer-readable recording medium. Moreover, A neural-network post-processing filter (NNPF) is applied on a current picture associated with the video based on at least one input picture for the NNPF, and a generation of at least one NNPF output picture is performed no more than once between any particular pair of consecutive input pictures.

Implementations of the present disclosure can be described in view of the following clauses, the features of which can be combined in any reasonable manner.

Clause 1. A method for video processing, comprising: performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

Clause 2. The method of clause 1, wherein for any particular pair of pictures consecutive in an output order in a list of decoded pictures in the output order resulted from decoding the bitstream, if there are one or more pictures in a list of NNPF output pictures that are between the particular pair of pictures in the output order, the one or more pictures are among pictures that are output by applying a particular NNPF with a purpose comprising picture rate upsampling when a first picture in the list of decoded pictures is the current picture.

Clause 3. The method of clause 2, wherein at least one of the following do not output any picture between the particular pair of pictures in the output order: an application of any NNPF that is different from the particular NNPF and used in a filtering process for one picture when the first picture is the current picture, or an application of any NNPF that is used in a filtering process for one picture when a second picture in the list of decoded pictures is the current picture, the second picture being different from the first picture.

Clause 4. The method of any of clauses 2-3, wherein the list of decoded pictures comprises at least one decoded picture or at least one cropped decoded picture of the video.

Clause 5. The method of any of clauses 1-4, wherein if a purpose of an NNPF comprises picture rate upsampling and the NNPF is allowed to be used for post-processing filtering for the current picture and all subsequent pictures of a current layer in an output order until a condition is met, one or more interpolated pictures are generated only between one pair of consecutive input pictures for the NNPF, and wherein the current layer is a layer comprising the current picture.

Clause 6. The method of clause 5, wherein an indication pictureRateUpsamplingFlag indicates whether the purpose of the NNPF comprises picture rate upsampling or not, or an indication nnpfa_persistence_flag indicates whether the NNPF is allowed to be used for post-processing filtering for the current picture and all subsequent pictures of the current layer in the output order until the condition is met.

Clause 7. The method of any of clauses 1-6, wherein a generation of at least one new picture is performed no more than once between any two consecutive pictures in an output order in the bitstream.

Clause 8. The method of any of clauses 1-6, wherein a generation of at least one new picture is performed no more than once between any two consecutive pictures in an output order in a coded layer video sequence (CLVS) in the bitstream.

Clause 9. The method of any of clauses 1-6, wherein for an NNPF with a purpose comprising picture rate upsampling, if the NNPF is activated for more than one picture in the bitstream, for any pair of consecutive pictures in an output order in the bitstream, at most one of the activations of the NNPF is allowed to interpolate pictures between that pair of consecutive pictures.

Clause 10. The method of any of clauses 1-9, wherein an output time instance of each of at least one generated picture during picture rate upsampling is specified.

Clause 11. The method of clause 10, wherein the output time instance of each of the at least one generated picture is determined based on that the at least one generated picture between two consecutive input pictures during picture rate upsampling is uniformly located between the two consecutive input pictures.

Clause 12. The method of any of clauses 10-11, wherein the output time instance of each of the at least one generated picture during picture rate upsampling is indicated based on one or more syntax elements.

Clause 13. The method of clause 12, wherein the one or more syntax elements indicate a difference between a picture order count (POC) of each of the at least one generated picture and a POC of a previous input picture or a previous generated picture.

Clause 14. The method of clause 12, wherein the one or more syntax elements indicate a difference between a POC of each of the at least one generated picture and a POC of a reference input picture that is the first input picture following that generated picture in the output order.

Clause 15. The method of any of clauses 12-14, wherein if the one or more syntax elements are absent from the bitstream, the output time instance of each of the at least one generated picture is inferred.

Clause 16. The method of any of clauses 1-15, wherein the current picture comprises a decoded picture or a cropped decoded picture of the video.

Clause 17. The method of any of clauses 1-16, wherein the conversion includes encoding the video into the bitstream.

Clause 18. The method of any of clauses 1-16, wherein the conversion includes decoding the video from the bitstream.

Clause 19. An apparatus for video processing comprising a processor and a non-transitory memory with instructions thereon, wherein the instructions upon execution by the processor, cause the processor to perform a method in accordance with any of clauses 1-18.

Clause 20. A non-transitory computer-readable storage medium storing instructions that cause a processor to perform a method in accordance with any of clauses 1-18.

Clause 21. A non-transitory computer-readable recording medium storing a bitstream of a video which is generated by a method performed by an apparatus for video processing, wherein the method comprises: performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

Clause 22. A method for storing a bitstream of a video, comprising: generating the bitstream from the video; and storing the bitstream in a non-transitory computer-readable recording medium, wherein a neural-network post-processing filter (NNPF) is applied on a current picture associated with the video based on at least one input picture for the NNPF, and a generation of at least one NNPF output picture is performed no more than once between any particular pair of consecutive input pictures.

### Example Device

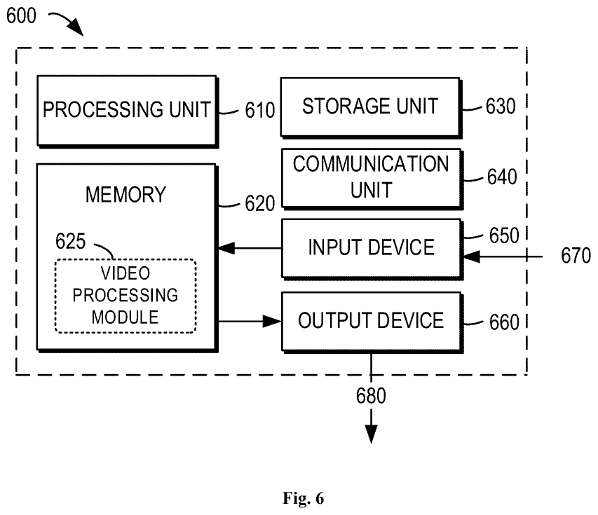

FIG. 6 illustrates a block diagram of a computing device 600 in which various embodiments of the present disclosure can be implemented. The computing device 600 may be implemented as or included in the source device 110 (or the video encoder 114 or 200) or the destination device 120 (or the video decoder 124 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement video encoding/decoding in embodiments of the present disclosure. The memory 620 may include one or more video coding modules 625 having one or more program instructions. These modules are accessible and executable by the processing unit 610 to perform the functionalities of the various embodiments described herein.

In the example embodiments of performing video encoding, the input device 650 may receive video data as an input 670 to be encoded. The video data may be processed, for example, by the video coding module 625, to generate an encoded bitstream. The encoded bitstream may be provided via the output device 660 as an output 680.

In the example embodiments of performing video decoding, the input device 650 may receive an encoded bitstream as the input 670. The encoded bitstream may be processed, for example, by the video coding module 625, to generate decoded video data. The decoded video data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

2. The method of claim 1, wherein for any particular pair of pictures consecutive in an output order in a list of decoded pictures in the output order resulted from decoding the bitstream, if there are one or more pictures in a list of NNPF output pictures that are between the particular pair of pictures in the output order, the one or more pictures are among pictures that are output by applying a particular NNPF with a purpose comprising picture rate upsampling when a first picture in the list of decoded pictures is the current picture.

3. The method of claim 2, wherein at least one of the following does not output any picture between the particular pair of pictures in the output order:
an application of any NNPF that is different from the particular NNPF and used in a filtering process for one picture when the first picture is the current picture, or
an application of any NNPF that is used in a filtering process for one picture when a second picture in the list of decoded pictures is the current picture, the second picture being different from the first picture.

4. The method of claim 2, wherein the list of decoded pictures comprises at least one decoded picture or at least one cropped decoded picture of the video.

5. The method of claim 1, wherein if a purpose of an NNPF comprises picture rate upsampling and the NNPF is allowed to be used for post-processing filtering for the current picture and all subsequent pictures of a current layer in an output order until a condition is met, one or more interpolated pictures are generated only between one pair of consecutive input pictures for the NNPF, and wherein the current layer is a layer comprising the current picture.

6. The method of claim 5, wherein an indication pictureRateUpsamplingFlag indicates whether the purpose of the NNPF comprises picture rate upsampling or not, or
an indication nnpfa_persistence_flag indicates whether the NNPF is allowed to be used for post-processing filtering for the current picture and all subsequent pictures of the current layer in the output order until the condition is met.

7. The method of claim 1, wherein a generation of at least one new picture is performed no more than once between any two consecutive pictures in an output order in the bitstream, or
wherein a generation of at least one new picture is performed no more than once between any two consecutive pictures in an output order in a coded layer video sequence (CLVS) in the bitstream, or
wherein for an NNPF with a purpose comprising picture rate upsampling, if the NNPF is activated for more than one picture in the bitstream, for any pair of consecutive pictures in an output order in the bitstream, at most one of the activations of the NNPF is allowed to interpolate pictures between that pair of consecutive pictures.

8. The method of claim 1, wherein an output time instance of each of at least one generated picture during picture rate upsampling is specified, and the output time instance of each of the at least one generated picture is determined based on that the at least one generated picture between two consecutive input pictures during picture rate upsampling is uniformly located between the two consecutive input pictures.

9. The method of claim 1, wherein the current picture comprises a decoded picture or a cropped decoded picture of the video.

10. The method of claim 1, wherein the conversion includes encoding the video into the bitstream.

11. The method of claim 1, wherein the conversion includes decoding the video from the bitstream.

12. An apparatus for video processing comprising a processor and a non-transitory memory with instructions thereon, wherein the instructions upon execution by the processor, cause the processor to perform operations comprising:
performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

13. The apparatus of claim 12, wherein for any particular pair of pictures consecutive in an output order in a list of decoded pictures in the output order resulted from decoding the bitstream, if there are one or more pictures in a list of NNPF output pictures that are between the particular pair of pictures in the output order, the one or more pictures are among pictures that are output by applying a particular NNPF with a purpose comprising picture rate upsampling when a first picture in the list of decoded pictures is the current picture.

14. The apparatus of claim 13, wherein at least one of the following does not output any picture between the particular pair of pictures in the output order:
an application of any NNPF that is different from the particular NNPF and used in a filtering process for one picture when the first picture is the current picture, or
an application of any NNPF that is used in a filtering process for one picture when a second picture in the list of decoded pictures is the current picture, the second picture being different from the first picture.

15. A non-transitory computer-readable storage medium storing instructions that cause a processor to perform operations comprising:
performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

16. The non-transitory computer-readable storage medium of claim 15, wherein for any particular pair of pictures consecutive in an output order in a list of decoded pictures in the output order resulted from decoding the bitstream, if there are one or more pictures in a list of NNPF output pictures that are between the particular pair of pictures in the output order, the one or more pictures are among pictures that are output by applying a particular NNPF with a purpose comprising picture rate upsampling when a first picture in the list of decoded pictures is the current picture.

17. The non-transitory computer-readable storage medium of claim 16, wherein at least one of the following does not output any picture between the particular pair of pictures in the output order:
an application of any NNPF that is different from the particular NNPF and used in a filtering process for one picture when the first picture is the current picture, or
an application of any NNPF that is used in a filtering process for one picture when a second picture in the list of decoded pictures is the current picture, the second picture being different from the first picture.

18. A non-transitory computer-readable recording medium storing a bitstream of a video which is generated by a method performed by an apparatus for video processing, wherein the method comprises:
performing a conversion between a video and a bitstream of the video, wherein a neural-network post-processing filter (NNPF) is applied on a current picture associated with the video based on at least one input picture for the NNPF, and a generation of at least one NNPF output picture is performed no more than once between any particular pair of consecutive input pictures.

19. The non-transitory computer-readable recording medium of claim 18, wherein for any particular pair of pictures consecutive in an output order in a list of decoded pictures in the output order resulted from decoding the bitstream, if there are one or more pictures in a list of NNPF output pictures that are between the particular pair of pictures in the output order, the one or more pictures are among pictures that are output by applying a particular NNPF with a purpose comprising picture rate upsampling when a first picture in the list of decoded pictures is the current picture.

20. The non-transitory computer-readable recording medium of claim 19, wherein at least one of the following does not output any picture between the particular pair of pictures in the output order:
an application of any NNPF that is different from the particular NNPF and used in a filtering process for one picture when the first picture is the current picture, or
an application of any NNPF that is used in a filtering process for one picture when a second picture in the list of decoded pictures is the current picture, the second picture being different from the first picture.
